(19) United States
(12) Patent Application Publication
(10) Pub. No.: US 2011/0074231 A1
(43) Pub. Date: Mar. 31, 2011

(54) Hybrid and electic vehicles magetic field and electro magnetic field interactice systems

(76) Inventor: Rod. F. Soderberg, Brisbane (AU)

(21) Appl. No.: 12/923,106

(22) Filed: Sep. 2, 2010

Related U.S. Application Data
(60) Provisional application No. 61/272,444, filed on Sep. 25, 2009.

(51) Int. Cl. H02K 1/02; H01F 3/00; H01F 7/02; B32B 15/02; B22D 27/02

(52) U.S. Cl. 310/44; 335/297; 335/302; 335/306; 428/558; 164/498

(57) ABSTRACT

A magnetic field interactive material being part of a machine component or mechanism utilizing magnetic or electro-magnetic field forces in said components operation and comprising specifically located magnetic particles incorporated into a non homogeneous amalgamation within the matrix or structural matrix of primarily a metal material differing from that of the magnetic particles therein forming an integrated component possessing magnetic field interactive capabilities, allowing such magnetic field interactive components to have a wide array of uses one of which is associated with Hybrid and Electric Vehicles.

### RELATED APPLICATIONS

This application claims the benefit of; U.S. Provisional Patent Application; 61/272,444 filed Sep. 25, 2009 Soderberg; which is hereby incorporated by reference in its entirety.

### BACKGROUND OF THE INVENTION

### 1. Field of the Invention

The present invention is primarily directed toward improving the efficiency of magnetic and electro-magnetic drive mechanisms and equipment utilizing magnetic field interaction and places particular emphasis on improvements which can be made to transport vehicles, hybrid and electric vehicles being of particular importance.

2. Description of Related Art

The present invention has a wide range of uses, virtually all types of electric motor and magnetic drive/propulsion or magnetic accelerator systems and levitation systems, magnetic bearings, eddy current brakes plus numerous other systems can benefit from features of this disclosure.

The following disclosure of the present invention contains numerous prior art references, in particular prior art patent references which disclose the state of the art in magnetic field interactive mechanisms, electro-magnetic field interactive mechanisms and a range of procedures for creating/manufacturing such mechanisms. Only a few of the cited references are considered to bear some amount of similarity to the present invention and these are highlighted and discussed in more detail within this disclosure however the vast majority of diverse works referenced are considered relevant to known technology, methods of manufacture and general knowledge in the state of the art associated with aspects of the present invention. These references are included because they clearly disclose methods, procedures, and state of the art technology by which the present invention can be manufactured. Knowledge of this state of the art also clearly defines the very significant difference between the prior art and the present invention.

The use of distributed magnetic particles in specifically located concentrations within a metal matrix is considered unique and novel in all purposes claimed while said magnetic particles in specifically located concentrations within a plastic/resin base is considered novel in the particular usages claimed.

Although the present invention is directed primarily toward integrating magnetic particles into the matrix and or structural matrix of components associated with mechanisms and machines, methods and principles of the present invention can be utilized to manufacture small or large magnetic field producing components, which can for example, be permanently magnetic systems with a single North-South pole or multipole systems wherein the magnetic material is located in specific regions and matrix material which can be strong yet ductile can be located primarily in regions used to attach the magnetic system which allows ease of attachment and which differs significantly from the prior art metal bonded or sintered magnets which are brittle and lacking ductility and are difficult to bolt or rivet and are not easily welded or brazed therein differing from the case with the present invention wherein matrix material is located as required and amalgamates magnetic particles into said matrix material in regions specifically requiring magnetic field interactive forces creating a non-homogeneous unit that differs totally from the homogeneous blend of particles and matrix binder which form a prior art permanent magnet.

As mentioned previously there are only a few prior art patents or patent applications which are considered to bear some similarity to the present invention. U.S. Pat. No. 7,703,717 Soderberg is a continuation of U.S. Pat. No. 7,594,626 filed Jan. 8, 2006. Herein incorporated by reference in its entirety.

This patent by the inventor of the present, invention introduces the concepts and principles of incorporating, amalgamating and integrating magnetic particles into the matrix and structural matrix of a magnetic field or electro-magnetic field interactive mechanism. This patent specifically locates and integrates magnetic particle material within the matrix or structural matrix of another material wherein the magnetic particles replace embedded or attached permanent magnet segments, therein defining the specific location and localized integration of said magnetic particles within a load bearing components matrix or structural matrix since the magnetic particles are replacing magnet segments with minimal material waste. As reference page 12 line 53 of U.S. Pat. No. 7,703,717 states “It should be noted that mention is made throughout this specification of incorporating magnetic material and magnetic field producing material into the structural matrix of a wheel assembly component and that this statement should in this specification be considered to define the engineering sense wherein the magnetic material or magnetic field producing elements are specifically designed, distributed, and configured to form structural load bearing elements within the component.” In this context it is clear that specifically designed, distributed and configured magnetic material allow formation of specific structural load bearing elements within a component describes separate distributions of magnetic material (magnetic particles) within a component matrix.

All claims relate to magnetic field interactive mechanisms, rotors, stators, disc and drum types which relate to a transport vehicle wheel assembly. Those skilled in the art will realize that the principles of the invention are relevant and analogous to a wide array of magnetic field interactive mechanisms and machines and that this prior art invention introduces principles of the present invention.

Principles claimed in U.S. Pat. No. 7,703,717 and utilized in the present invention include ; claim 1 “said rotating components comprising magnetic particles, which give rise to magnetic field forces, distributed within at least one rotating components structural matrix”, claim 4 “wherein at least one component . . . is comprised of a material which possess both structural load bearing capacity and a capability to maintain magnetic field forces and is thereby defined as a Synthetic Multifunctional Material”. Claim 5 “wherein the Synthetic Multifunctional Material is comprised of a structural matrix of magnetic particles interspersed within at least one of; a metallic material, . . . a non-metallic material, a carbon composite”. As defined by the disclosure and the claims this prior art Patent utilizes magnetic particles specifically designed, distributed and configured so as to integrate said magnetic particles into specific locations and configuration (arrays) within the structural matrix of a component so as to form structural load bearing components. These same principles are utilized in the present invention and involve specifically located magnetic particles to optimize both structural properties and magnetic field properties of a material or component.

Several prior art inventions, which utilize magnetic particles embedded within a resin/plastic binder which may also be fibre reinforced are listed and discussed.

U.S. Pat. No. 5,477,092 Tarrant. PCT/93/01881 Sep. 6, 1993 Rotor discloses a high speed electric motor/generator comprising fibre reinforced plastic, for example carbon fibre in an epoxy resin matrix, with magnetic particles in a resin matrix in specific spaces within layers of for example carbon fibre with reinforced plastic/resin, forming the outer section of a rotor wherein the magnetic flux created by the magnetic particles interacts with external stator drive coils in proximity. This patent discloses a relatively conventional high speed fibre reinforced resin bound composite rotor with a unique characteristic of specific locations within the rotor containing magnetic particles within a resin/plastic matrix.

U.S. Pat. No. 6,154,352 Atallah PCT/GB97/00895 filed Mar. 27, 1997 Method of Magnetizing a Cylindrical Body, disclosed a method of magnetizing a cylindrical body comprising a reinforcing layer of fibres for example carbon fibre in a resin binder matrix and a magnetic layer comprising distributed magnetic material/particles in a resin binder matrix, the magnetic layer being provided in the form of at least one slab. The magnetic material is concentrated in separate discrete segments wherein the magnetic material is distributed substantially homogeneously throughout the magnetic layer, a layout which enhances magnetic loading over that of Tarrant which utilizes cells within spaces of the composite body. As with Tarrant a resin/plastic bound composite is utilized.

U.S. Patent Application 2003/0084888 LeBold et. al filed Nov. 8, 2001. Supercharger Type Compressor/Generator with Magnetically Loaded Composite Rotor, disclosed a high speed resin composite rotor and references both above referenced Patents of Tarrant and Atallah, and again utilizes resin/plastic composites and magnetic material bound within a resin matrix.

U.S. Patent Application 2008/0044680 Thibodeau et. al filed Aug. 20, 2007 priority based on U.S. Provisional Application No. 60/838,737 filed Aug. 18, 2006. Magnetic Composites discloses a magnetic material composite resin/plastic bound matrix with specifically located regions of magnetic material similar to the prior listed patent references however in this case the binder materials epoxies, polymeric material and the like are claimed as structural materials defined as having load bearing capacity. Manufacturing and molding procedure in one aspect of the invention describe the magnetic material, and structural material mixture to which is applied magnetic field forces associated with the mold in order to align anisotropic magnetic materials which is practiced in the manufacture of anisotropic permanent magnets, however in this case the magnetic material composite mixes magnetic material with structural material in the form of resin/plastic and the mold applied magnetic fields both align and attract or cause to migrate the anisotropic magnetic materials and tend to separate these materials from the structural material. Additionally handling of materials, placing in molds, and magnetizing the product, all apply to procedures associated with resin/plastic composites.

As with all of the prior referenced Patents and Patent Applications this application relates specifically in all aspects to resin/plastic bound composites. However this application additionally claims a magnetic material within a structural material as an important aspect, “wherein said structural material is configured to provide structural support to withstand a load placed on the magnetic material composite.”

Inspection of drawings FIGS. 1, 2 and 3 of U.S. Pat. No. 773,717 Soderberg show a number of locations as example of locations for placement or attachment, embedment or incorporation of magnetic field producing materials or elements. As stated in the Patent disclosure and as claimed, magnetic field producing medium in the form of magnetic particles can be incorporated into the matrix or structural matrix of a component in place of an attached or embedded permanent permanent magnet segment, while maintaining the structural integrity of the component. The locations marked on the drawings as example of potential location positions for said integrated magnetic particles clearly show specific, localized positions. It is also stated that the distribution of magnetic field producing medium or material could also occupy a region joining a number of locations.

In summary the prior art U.S. Pat. No. 7,703,717 discloses and claims (Claim 1″) rotating components comprising magnetic particles, which give rise to magnetic field forces, distributed within at least one rotating components structural matrix. (Claim 4)″ wherein at least one component of the wheel assembly contain rotational components and static components is comprised of a material which possess both structural load bearing capacity and a capability to maintain magnetic field forces and is thereby defined as a Synthetic Multifunctional Material” (Claim 5)″ The wheel assembly of claim 4 wherein the Synthetic Multifunctional Material is comprised of a structural matrix of magnetic particles interspersed within at least one of ; a metallic material a sintered metallic material, sintered magnetic particles, a non-metallic material, a carbon composite,” which can be defined as a mechanism with a mode of operation based on the interaction of magnetic field force with an element which responds to said magnetic field force.

The above claim references relate primarily to a rotor structure of a magnetic field and or electro-magnetic field interactive mechanism or machine. (Claim 6)″ The wheel assembly of claim 4 wherein the Synthetic Multifunctional Material has a structural matrix comprising at least one of: a carbon composite material, magnetic particles, sintered magnetic particles, a metallic material, a sintered metallic material, soft magnetic material, sintered soft magnetic material, incorporating within said structural matrix a conductive material forming an electrical circuit incorporated within the Synthetic Multifunctional Material so as to form a composite part of said structural matrix whereby an electric current applied to the conductive material gives rise to magnetic field forces” claim 6 is relevant to the stator, field winding/drive coil, section of the magnetic field and or electro-magnetic field interactive mechanism or machine. Components of principles associated with all the above referenced claims are utilized in the present invention.

It will also be noted that the previously referenced patents and patent application of Tarrant, Atallah, LeBold et al., and Thibodeau et al., all applications utilize resin/plastic matrix bonded fibre composites and only one, that of Thibodeau et al. claims the inclusion of a magnetic material within a structural material however the claim of a magnetic material incorporated and integrated into the structural matrix of a magnetic field and or electro-magnetic field interactive mechanism or machine has previously been claimed by Soderberg in U.S. Pat. No. 7,703,717, which in this instance does not constitute a conflicting prior art document in the case of the present invention also by Soderberg. It should be considered that the present invention be considered novel in relation to the referenced prior art, especially so in the case of the primary embodiment of the present invention which utilizes a metal matrix material in place of the resin/plastic matrix materials of the prior art. In the case of a resin/plastic matrix utilized by the present invention the method of usage and the inclusion of magnetic particles within the structural matrix of a component should be considered to significantly differentiate such an embodiment from the prior art.

### Description of the Present Invention

Hybrid and electrically motivated vehicles including Hydrogen Fuel Cell electric vehicles and the wide array of equipment utilizing magnetic field interaction associated with such vehicles as example electric motors associated with the main drive system and secondary equipment such as ; for example, steering servo-motors, air-conditioning pumps, water and oil pumps, fan motors and even DVD drives can be significantly improved in terms of ease of production, component weight and size reduction along with improved structural integrity and reliability by incorporation and amalgamation of specifically located concentrations of magnetic particles within a component matrix or structural matrix. It will be clear to those skilled in the art that disclosures of this invention can be equally well applied to components of electric motors, machines, tools and equipment, such items which employ an interaction of magnetic field forces can utilize this present invention to improve efficiency, improve structural integrity, reduce weight and complexity, ease production and reduce costs of manufacture especially in the field of mass production.

Hybrid vehicles can be defined as vehicles with several different sources of power for the drive train, for example an internal combustion engined vehicle with additional electric motor drive systems. The necessity to save resources and reduce “green house” gasses along with current and future legislation make hybrid and electric vehicle development essential. Down sizing of an internal combustion engines capacity is a method for fuel saving and reducing pollution.

However small engined vehicles often offer lower performance and differing drivability characteristics to the larger engined vehicles they replace, which along with cost considerations may limit their desirability.

A wide range of electric motors including in-wheel electro-magnetic drive systems, can be designed to have a wide range of characteristics, they can offer very high torque from start up and in association with electronic control, inverters, and micro-processors can produce high efficiency along with precise control. Incorporation of a well integrated electric drive as a primary power source or in combination with an internal combustion engine can create a vehicle with good performance and drivability characteristics.

In order to greatly improve drivability characteristics of a small internal combustion engined vehicle such as a hybrid vehicle generally requires only a relatively short burst of electric drive power precisely controlled to “fill in” performance short falls in the internal combustion engine, thereby greatly improving drivability and performance while also allowing the small internal combustion engine to operate more efficiently in its optimum range, outside this range electric motor assistance reduces load on the engine further improving efficiency.

Vehicles so designed may chose to utilize the so called “super” or “ultra” capacitors in combination with a smaller battery pack. Such capacitors charge and discharge large amounts of electrical energy without the chemical reactions and heat associated with batteries, thus capacitors can last a long time and by relieving the rapid charge and discharge from any battery used, battery life can be extended, and battery cost reduced.

Improving the overall efficiency of all systems utilizing electric power is essential to the development of Hybrid and electric vehicles.

The present invention utilizes a number of methods to integrate highly efficient electro-magnetic and magnetic drive systems into the matrix of rotational or lineal motion and static components of a vehicle drive system which has a capacity to drive, brake and regenerate energy in a system which is potentially lighter less space consuming, more robust and reliable, highly suited to mass production and thus more cost efficient than current technology.

In one embodiment of the invention it is the method of integrating, concentrating and specifically locating magnetic field producing medium into the matrix or structural matrix of a component which differentiates the present invention from prior art. In another embodiment of the present invention it is the magnetic field array and the mode of containment within a component which differentiates the present invention from prior art.

As example an important component of Hybrid and Electric Vehicle and many other vehicles is a servo-power assisted steering mechanism. Electric servo assistance is taking over from hydraulic oil based servo systems and these electric systems are generally “contact” type systems, for example an electronically controlled electric motor directly geared into the steering mechanism to assist the drivers steering input. Such a contact system invariably absorbs some “feed back” from the tyre to road interface and may in fact be micro-processor controlled so as to create “feed back” to the driver similar to that which would be normal “feed back” from the road to tyre interface. Partial or full elimination of road feed back is desirable to some drivers while un-acceptable to others. The present invention allows all criteria to be met in a single system by integrating servo and steering mechanism into a single unit, an example of one of many multifunctional systems which can be created by the present invention thereby reducing component, weight and space wastage.

Precise “feed back” of road “feel” can best be achieved by a non contact servo-system, wherein as example the equivalent of a linear motor is formed utilizing, the steering rack of the steering mechanism and said steering racks casing, wherein the casing incorporates electrically induced magnetic field forces which may result from a field coil winding or alternative arrangement and these fields impose a pull or push axially on the steering rack, said steering rack incorporating appropriate magnetic particles in specifically located concentrations within the steering racks matrix or structural matrix. Such a system allows micro-processor or electronic control which can accommodate all steering “feed back” requirements. It also eliminates the servo-motor which is an additional item in prior art. An alternative non contact system could be achieved by attaching a magnetic particle integrated disc or drum to the steering column and then applying appropriate contactless field forces via a stator field in proximity, very similar to a linear motor rolled into a cylindrical form.

Improving the efficiency of all magnetic and electro-magnetic field interactive components associated with Hybrid and electric vehicles is essential to the overall vehicle efficiency and viability.

Virtually all forms of electric motor, electro-magnetic drive system, magnetic power transfer system and magnetic propulsion and or levitation system and material accelerator system can utilize aspects of the present invention to improve critical aspects of their design.

A brushed DC motor for example utilizing slip rings in place of commutators and electronic control of power supply can achieve long term service of brushes due to elimination of arching and reduction or elimination of back EMF due to precise electronic control such a machine utilizing embodiments of the present invention can create a very compact, powerful machine wherein as example magnetic particle are specifically concentrated in the machine casing wherein the casing provides the architectural and structural requirements of a casing while the concentrations of magnetic particles concentrated in specific arrays within the casing which is preferably a metal matrix or metal bond structural matrix type material specifically suited to a heavy duty, rugid environment found in Hybrid and electric vehicles, heavy duty machines and mechanisms although said matrix may be plastic in the case of for example a portable tool, or electric tooth brush, allowing a much more compact and integrated design since attached or embedded permanent magnet segments are no longer required. The concept of incorporating and amalgamating magnetic particles into the matrix or structural matrix of load bearing mechanisms is claimed by the inventor of the present invention in U.S. Pat. No. 7,703,717 Soderberg.

The majority of hybrid and electric vehicles presently manufactured or under development utilize permanent magnet motors as their electric drive which are generally either Brushless DC or Brushless AC permanent magnet synchronous motors.

These motors utilize easily available electronic control units, inverters, micro-processors and other solid state power drives to provide economical high performance solutions.

Brushed DC motors and Induction motors are used to a lesser extent.

Virtually all high performance permanent magnet electric motors utilize segments of rare earth magnets. The segments are either attached to or embedded into the rotor of most motors although brushed motors can have the segments attached to the stator section of the motor. Due to their high magnetic flux density rare earth magnets such as neodymium, iron, boron, (Nd Fe B) along with a range of alternative rare earth elements and alloying metals are used in permanent magnet electric motors. Reducing weight and complexity while improving structural integrity of such permanent magnet motors is an important attribute of the present invention.

Although the use of permanent magnet segments is common there are significant deficiencies in the practice since segments require precise machining, and are difficult to assemble, due in part to strong attraction/repulsion forces. Embedment into a motor component which may involve injection or pressure molding of a liquid or plastic mix of magnetic particles and binder material into voids within the component or installing of solid magnets into a cavity is both time consuming and costly and result in a component which due to voids and cavities is of reduced structural integrity.

Attachment of magnet segments to the outer region of a component, for instance the periphery of a motor rotor; a rotational component of a drive system which may be for example, a flywheel, a drive shaft; gear shaft gear cluster; or wheel assembly of a vehicle drive line results in a component with high magnetic flux density, however precise location, alignment and holding segments in place is difficult; some form of banding is often required to retain segments under rotational centrifugal loading, balancing and precise rotational alignment is also difficult resulting in wider tolerance applied to flux air gaps between the rotor and stator which reduces efficiency and the very nature of having heavy segments attached to the extremity of a rotor element limits rotational speed as high speed can dislodge segments.

The present invention successfully addresses these limitations while also addressing the requirement of hybrid and electric vehicle design of reduced size, reduced weight, reduced complexity, ease of fabrication and suitability for mass production thus reducing costs, characteristics which are also beneficial to numerous other machines, tools and equipment.

As example of current state of the art associated with permanent magnet motors.

U.S. Patent Application 20090001831 Cho, Axial Field Electric Motor, shows the basic configuration of a brushless, axial field, permanent magnet motor and shows a rotor with a plurality of permanent magnets secured together by a rotor retaining ring, a representative radial field brushless motor is also shown wherein the rotor comprises a plurality of permanent magnets of alternating polarity secured in location around the rotor back iron, (which completes the magnetic flux circuit), by a retaining ring.

U.S. Patent Application 20090072649—Rottmerhusem, Electronically Commutated Electric Motors states such motors, typically have a permanent magnet excited rotor, wherein the rotor is either equipped with individual permanent magnets, or a multipole ring magnet is arranged on the rotor, and in a motor with small diameter the rotor itself is frequently made of a permanent magnet having multiple magnetized poles. The magnetization direction of the magnet or magnets of such rotors is primarily perpendicular to the air gap of the motor.

Application 20090072649 also shows a motor design which allows high loading of the drive coils while reducing risk of demagnetization of the permanent magnets. A second embodiment of the present invention also addresses this demagnetization problem.

Also of interest within the description is that of rotors with a multiple ring magnet arranged on the rotor which is a separate ring of uniformly distributed permanent magnet particles either sintered together or distributed within a binder material to form a solid permanent magnet. Smaller rotors which are made completely of a similar permanent magnet particle blend are available. These rotors and other permanent magnet rotors and rotor rings are made up of a continuous uniform blend of magnetic particles throughout. Small stepper motors using a formed to shape magnet with multiple magnetized poles characterize these motors. Those rotors are inefficient in their usage of magnetic material, when it is spread over significant depth since magnetic material very distant from the stator/rotor air gap is of lesser benefit. Also the highly concentrated magnetic particle blend formed into the total magnet tends to lack structural integrity. To date such blends are limited to relatively small, lightly stressed rotors. Magnetic Particles fused together or bonded together into a predetermine shape are described in; U.S. Pat. No. 6,387,294 Yamashita et al. filed, Oct. 10, 2000. Resin Bound Rare Earth Magnet Formed to Shape.

U.S. Pat. No. 7,618,496 filed Sep. 17, 2005 Sato et al. and Application 20100019587-Sato et. al. Radial Anisotropic Sintered Magnet Rotor Using Sintered Magnet, Motor using Magnet Rotor. These disclosures describe a formed to shape magnet such as a cylindrical magnet with magnetized sections supported on for instance an axial shaft. A high concentration of magnetic particles is desirable for creation of high field strength permanent magnets generally having well in excess of 90% of their volume containing magnetic material being fused/Sintered or bonded magnetic particles.

Such materials and components formed from such materials generally lack the structural integrity required of the present invention, for example fused and sintered magnets are often brittle and lacking in impact resistance, ductility, tensile and bending strength, while injectable plastic or polymer bonded magnets generally lack rigidity and thermal resistance and find use for example as strips of magnet material attached to a “back iron” support. Small brushless motors used for DVD and hard drives are an example of such rotors. Such “out runner motors” are often used in model aircraft with power increased by replacing their bonded magnet strips with individual Nd Fe B magnets. One embodiment of the present invention would replace the magnetic strip or Nd Fe B magnets attached to a rotor periphery with a structurally sound rotor containing within its matrix specifically located concentrations of Magnetic Particles. Differing from the prior art in that the concentration of magnetic particles is specifically located where the magnetized pole and flux paths are required as opposed to the prior art which spreads the magnetic particles through the entire magnet then selectively magnetizes poles within the large regions of magnetic particle, which is quite inefficient in terms of material usage.

Thus the present invention in one embodiment which will be described as the first embodiment utilizes magnetic particles; being either permanently magnetic particles or soft magnetic particles which become magnetic under the influence of a magnetic field, including electrically conductive particles; with specific concentrations in specific regions of a load bearing component such as for example, a vehicle wheel rim which requires high strength, good rigidity and impact resistance; or a fly wheel, some of which when used as energy storing motor/generators can rotate at extremely high rates which impose centrifugal forces approaching the limits of the highest strength metals or composites. Many of the uses proposed of the present invention are novel and outside the field of usage of the prior art, while a first embodiment of the present invention allows the creation of electro-magnetic or magnetic field interactive machines unlike those of the prior state of the art wherein components of these “new” machines utilizing the present invention can often serve a multifunctional role as a magnetic field producing component and a machine component in a single integrated component, U.S. Pat. No. 7,703,717 Soderberg defines this type of structural multifunction material/component as a Synthetic Multifunction Material. Said U.S. Pat. No. 7,703,717, being herein incorporated in its entirety.

Unlike a formed to shape magnet with an approximately uniform blend of particles throughout, the present invention specifically concentrates, locates, and aligns magnetic particles within specific regions of a components matrix or structural matrix, said particles becoming part of the component structure in regions where said particles are most beneficial while maintaining the overall structural integrity of the component by retaining matrix material in specific regions as required thereby forming an integral component with both magnetic field capacity and structural capabilities, which for the purposes of the present invention shall be described as either a Multifunctional Component or a Synthetic Multifunctional Component. The present invention can create internal magnetic discontinuities in a core therein acting like segments or physical discontinuities in reluctance or combined reluctance and magnetic torque type machines for example Interior Permanent Magnet (IPM) machines.

As example of the prior/current art; U.S. Pat. No. 7,402,934 Gabrys filed Aug. 18, 2005 details both drum and disc motor/generators with air core windings. The motor/generator in disc form resembles a similar high efficiency disc drive designed for solar challenge cars by the C.S.I.R.O Australia which additionally utilized a Halbach array for permanent magnet segments in order to concentrate magnetic field forces on the side closest to the field windings, there are numerous motor/generators which bear similarity to U.S. Pat. No. 7,402,934. Almost all utilize permanent magnet segments, embedded, attached to, or injected into cavities within, a rotor, all such designs can benefit from the present invention by making the magnetic material a part of the matrix or structural matrix of the rotor, and or stator for some specific designs thereby greatly increasing structural integrity and robustness of the machine component while potentially reducing size and weight.

It should also be noted that reluctance type machines and combination of reluctance and permanent magnet type machines for example Interior Permanent Magnet machines can make use of solid or semi-solid rotors with cavities or voids, wherein these rotors can have physical and or structural discontinuities such as slots, raised or lowered sections or additions to said rotors which create discontinuities in flux path to the benefit of machine efficiency. Principles of the present invention can be utilized to create “non visible” (either physically or structurally), flux discontinuities in rotors by integrating permanently magnetic particles, soft magnetic particles, and or electrically conductive particles into the matrix of an otherwise homogeneous rotor.

As previously mentioned the prior state of the art utilize a magnet formed to the shape of for instance a small rotor wherein the total rotor, whether solid or containing hollow section, is comprised of for example, an approximately uniform blend of compacted and sintered magnetic particles which may or may not include a small percentage of binder material or alternatively, as example; the magnetic particles may be bound in an approximately uniform homogeneous blend of magnetic particles and thermo-plastic, resin, or polymer which is quite often used as a ring or cylinder attached to the periphery of a rotor adjacent to stator windings in a multipole magnetized form. These are generally described as formed to shape magnets and are potentially highly inefficient in terms of magnetic material usage and structural integrity.

However several prior art Patents and at least one Patent Application claim inclusion of non homogeneous concentrations of magnetic particles exclusively within a resin bound magnetic composite. An application claims a resin bound non homogeneous magnetic material claiming incorporation within a structural material. However as previously noted U.S. Pat. No. 7,703,717 Soderberg specifically claims incorporation of magnetic particles within a material or components structural matrix thereby creating a load bearing structural component while clearly defining the intended usage of “structural”, wherein it will be clear to those skilled in the art that said mechanism/machine represents an electro-magnetic field, magnetic field interactive machine, equivalent to disc, drum or liner drive motors.

Additionally although the present invention makes use of resin/plastic structural matrix material the primary structural matrix utilized is that of a metal matrix.

A first embodiment of the present invention differs significantly from the prior state of the art by blending magnetic particles, either permanently magnetic particles or soft magnetic particles or electrically conductive particles, which become magnetic under the influence of a magnetic field or a blend of these types of particles, into the matrix or structural matrix of a component of differing material to that of the magnetic particle material wherein the concentration of magnetic particles is specifically controlled in relation to location within the component. For the purposes of this disclosure “magnetic particles” shall describe; permanently magnetic particles as example Nd Fe B particles; or particles which become magnetic under the influence of a magnetic or electromagnetic field, these can be; soft magnetic particles, as example, iron dust, permalloy or AncorLam or electrically conductive particles as for example, copper or aluminium particles.

Thus magnetic particles in high concentrations are placed where they are most beneficial, such high concentrations can create, a defined array of magnetic flux locations, flux directions, and pole alignments, and flux paths while regions of the component which do not require strong magnetic fields but which for example require high degrees of structural integrity, eg. ductility, impact resistance, tensile and or compressive or bending strength, weight control, balance and eccentricity control can be formed of a base material highly suited to the requirements of the particular region within said component. This allows the component designer to create a composite integral unit which combines structural integrity as a result of placing specific materials exactly where they are required for purpose and arranging magnetic fields and high intensity flux locations exactly where these are required, without waste of placing magnetic material where it serves little or no useful magnetic purpose but is often detrimental to structural integrity especially important in the case of metal matrix materials where specific metallurgical characteristics are critical to structural integrity. It allows the designer a realm of freedom to locate magnetic field forces and field alignments (Pole directions) in arrangements that are beyond the constraints and limitations associated with attachment or embedment of magnet segments and complex magnet segment arrays or formed to shape magnets including resin bound non homogenous magnetic composites which are primarily restricted in terms of heat resistance and limited bearing stress resistance especially in regions of bolted/riveted connections. Structural integrity is greatly improved as is durability; balance and machine tolerances are improved, while the potential for mass production can potentially result in very significant cost savings over what is virtually a hand built rotor or component in the case of attached magnet segments; weight is potentially reduced, rotor speed can safely increase and material wastage is reduced since magnetic and structural materials are placed where they are most efficiently utilized.

The matrix and or structurally critical regions of a component can be easily manufactured from for example particles of aluminium powder which may be mixed with specially treated short easily blended fibres or specifically aligned longer fibres of carbon, ceramic, boron, or similar for additional reinforcement as may also be utilized with magnetic particles thereby forming a region of Metal Matrix Composite wherein specific regions requiring magnetic flux forces may further contain concentrations of specially treated magnetic particles which are thereby compatible with integration into the component matrix, and in particular the component metal matrix.

A primary characteristic of several embodiments of the present invention which separates it in terms of novelty and inventiveness from other prior art results in part from the method of housing the drive system, at least part of which is incorporated, amalgamated and integrated into the matrix or structural matrix of a component of the drive system.

A second embodiment of the present invention relates to reducing the possibility of demagnetizing the magnets of a permanent magnet motor while increasing available torque and improving high rotational speed characteristics. U.S. Pat. Application 20090072649 Rottmerhusen has been previously referenced as providing a description of current state of the art in Permanent Magnet Motor Design. This application also describes a motor design which allows increased motor torque without risk of Permanent Magnet demagnetization which is a critical constraint relating to Permanent Magnet Motors. In this referenced application control of demagnetization is achieved by electronic control of the stator field and suitably orienting the permanent magnet rotor poles relative to the application of the stator field.

The second embodiment of the present invention utilizes field winding coils to apply an approximately coaxial magnetic flux to a magnetic core material which may be either a “conventional” permanent magnet segment or a combination of magnetic particles with core either hollow or solid comprising as example magnetic particles of, Nd Fe B. Rare Earth permanent magnets can be considered to have a reluctance similar to an air core. The coil winding and current direction are such that the coil and magnet fluxes are approximately co-axial with poles in the same direction. As example, this arrangement can be part of a permanent magnet motor rotor core, which will require slip rings to transfer power to the rotor coils which are wound to apply a co-axial flux to the rotor permanent magnets. The stator windings are generally timed so that one stator region repels a rotor pole while another in the direction of rotor rotation will attract the rotor pole. Under conditions of for example high torque output and low speed or stall condition the rotor permanent magnets are at risk of demagnetizing. Stronger more intense permanent magnet fields will generally allow higher motor torque prior to the onset of demagnetization. Thus permanent magnet arrays which concentrate magnetic flux on the air gap side of the rotor and or stator generally improve motor torque capacity however as motor speed increases these permanent magnet fields start to interact significantly with the drive coils creating induced back EMF which counteracts rotor drive, thus permanent magnet flux weakening at higher speeds is highly desirable. It should also be noted that many electric motors contain a large amount of iron, generally in the form of thin steel laminates, within their stator and rotor, such iron creates essential magnetic flux paths and assists in concentrating and locating magnet flux. However this bulk of iron/steel within the motor creates “iron” losses which are a primary source of inefficiency and heat, also adding bulk and weight and creates a heat sink which is not easily cooled. Such characteristics are considered undesirable for the high efficiency, high performance, compact motors which are of primary importance to the present invention and are successfully addressed within embodiments of this disclosure. Demagnetizing under high torque and field weakening at speed are addressed by the second embodiment of the present invention. A number of relevant patents are sited within this disclosure also of reference is; Field Weakening of Permanent Magnet Machines-Design Approaches. T. A. Lipo and M. Aydin. Electrical and Computer Engineering Dept. University of Wisconsin-Madison. This paper discusses the problem of back EMF and avoiding demagnetizing while also showing a wide range of different designs of permanent magnet motors all of which contain solid magnet segments either attached or embedded which is characteristic of the prior state of the art unlike the present invention first embodiment which utilizes specifically located concentrations of magnetic particles, also of interest is the method of controlling demagnetization, none of the prior art show co-axial magnet coils or coils specifically located and oriented to apply a co-axial field to the magnetic material to deal with demagnetization and high speed flux weakening as is the case with the second embodiment of this present invention.

Coils wound for example coaxially about a permanent magnet core and energized to reinforce the permanent magnet flux effectively increase available motor torque while effectively delaying or deferring the onset of demagnetization, as speed increases coil energizing is diminished until only the permanent magnet flux is functional. In this form an initially weaker total permanent magnet flux can due to coil reinforcement create torque equivalent to a stronger permanent magnetic flux while offering the advantage of weaker flux at higher speeds with associated efficiency and speed benefits. Additionally it is possible with precise electronic control, which takes into account magnet characteristics, temperature, load and an array of motor design characteristics, to allow a “reverse” field to be energized in the coil wherein the total flux generated by the combined effect of the permanent magnet and the coil is less than that of the permanent magnet acting alone, thus further enhancing high speed motor performance and efficiency. Precise electronic control of the coil is essential to avoid partial or total demagnetizing, additionally a coil specifically designed for purpose can also be used to magnetize or re-magnetize the permanent magnets thus potentially improving magnetized characteristics of the assembled motor which has flux paths completed after assembly allowing magnets to support higher flux densities and also has the capacity to re-magnetize an accidently demagnetized motor or a motor which is only partially magnetized to ease assembly.

This embodiment is suitable for use with permanent magnet segments, permanently magnetic particles and magnetic particle systems disclosed in the first embodiment of the present invention. Additionally a reluctance machine with precise electronic timing and control can utilize a core wherein a co-axial coil has a current applied to reinforce an induced magnetic field in said coil and core material contained within said coil wherein the core is magnetic or becomes magnetic under the influence of an external magnetic field and utilizes a particle core formed from at least one of; soft magnetic particles or permanently magnetic particles or electrically conductive non magnetic particles or a combination of said particles since coil current can be precisely controlled in terms of field orientation so that coil and core poles correspond as desired, thereby bearing similarity to the previously purely permanent magnet core with coil thus the second embodiment can also benefit a reluctance or combined reluctance and permanent magnet type machine such as an Interior Permanent Magnet machine (IPM) possessing both magnetic torque and reluctance torque. Coil activation can be by any suitable means of power transfer, for example, brushes and slip rings in conjunction with precise electronic control.

Utilizing coil field reinforcing and or field weakening with a core material comprising specifically located concentrations of magnetic particles as disclosed in the second embodiment of the present invention result in a machine component that is both novel and of practical worth.

The second embodiment of the present invention utilizing coaxially applied magnetic flux to reinforce permanently magnetic material in order to increase machine torque capacity while reducing the possibility of demagnetization while providing field weakening capabilities as required is considered unique and novel in the field of permanent magnet segment usage and magnetic particle usage.

U.S. Pat. No. 7,598,646 Cleveland Filed Feb. 26, 2007. Electric Motor with Halbach Arrays.

FIG. 1: Shows separate permanent magnet segments arranged in a Halbach Array with an equivalent coil array of separate electro-magnets.

This referenced patent claims; a plurality of permanent magnets arranged in a first Halbach array and a plurality of electro-magnets with coils arranged in a second Halbach array with controller inducing second magnetic fields wherein a second magnetic field substantially exhibits a second Halbach flux distribution.

The present invention can create economic advantage when compared with the referenced method due to; reducing the complexity of this arrangement while also improving structural integrity and making manufacture less difficult, for reasons further explained within this disclosure.

U.S. Pat. NO. 6,841,910 Jean Marc Gery filed Oct. 2, 2002 Magnetic Coupling using Halbach type magnet array.

FIG. 2: Shows both axial flux and radial flux machines wherein both the primary drive section and the secondary drive section contain interacting Halbach Magnet Arrays created by pluralities of magnet segments.

It will be clear that fabrication and assembly of such magnet arrays is difficult, structural integrity is also compromised and can limit rotational speed. The present invention can reduce complexity, easing assembly, and significantly improve structural integrity.

In both a first and second embodiment of the present invention significant non obvious differences exist between prior art and the present invention in the first embodiment separate magnet segments are not used, the component itself incorporates a specifically concentrated, located and field aligned clusters of magnetic particles forming part of the matrix or structural of the component. The flux path is continuous within the component rather than broken at different interfaces as is the case with separate magnet segments, the field created suffers no losses due to the small air-gaps between separate segments. The field created results from specifically located concentrations of magnetic particle material distributed in a non homogeneous blend within a matrix material and is not created by an array of specifically oriented separate magnet segments linked together in a specific array such as a Halbach array nor by a homogeneous blend of permanently magnetic particles. The present invention creates a concentrated magnetic flux on a particular chosen surface and replaces permanent magnet segments with specifically located concentrations of permanently magnetic particles which are part of the component matrix or structural matrix.

A third embodiment of the present invention can achieve the high magnetic flux generated predominantly on one face by the Halbach coil arrays of U.S. Pat. No. 7,598,646, wherein the third embodiment of the present invention utilizes a series of continuous V shaped coils and cores to achieve a highly localized “one-sided” flux, as opposed to the multiple coils and cores of the Halbach electro-magnet coil arrays. This third embodiment involves the primary electro-magnetic flux which is created by a continuous V shaped coil and core not by an array of individual coils set out in a Halbach Array. Differing significantly from the present state of the art in Halbach coil and magnet arrays as disclosed in U.S. Pat. No. 7,598,646—Cleveland Filed Feb. 26, 2007.

The present invention sets out these V shaped coils in a sequence, or series of similar V shaped coils around for example the inner periphery of a cylindrical motor casing in the region normally occupied by stator teeth; and may actually form part of the structure of the casing itself as it is not essential for the casing to be formed of a magnetic material nor is back iron required as the V cores create a magnetic flux path; and interact with a radial or approximately radial field or a field skewed away from the radial direction created by suitably concentrated and located magnetic particles incorporated and amalgamated into the matrix or structural matrix of for example a cylindrical rotor periphery. A similar arrangement can be associated with rotor and stator discs, cones, or virtually any interrelated shapes rotational or linear displacement which have relative motion in proximity to one another. This embodiment of the present invention utilizing a unique coil arrangement which is not a Halbach array of separate coils however by arranging like poles adjacent to one another on the air gap side it does create strong fields on one side for example the rotor air gap side while the continuity of coil and flux reduces flux “losses” on the back face eg. the point of the base of the V reducing back face flux and losses due to shortening the flux path and reducing or eliminating back iron.

The third embodiment of the present invention utilizing specially shaped coils which may be V shaped field winding coils which can be wound around specifically shaped and located core arrangements which apart from the conventional soft magnetic particle core may utilize for example magnetic particles these being permanently magnetic particles whereby a current which may be a unidirectional current either DC, attenuated or rectified AC, or pulsed DC is activated in the coil to reinforce the magnetic field of the permanently magnetic particles wherein both the magnetic field producing particles and the electro-magnetic field of the coil windings possess coaxial like poles when reinforcing therein creating a variable permanent magnet type stator which would react with an electronically controlled brush and slip ring rotor or commutated rotor, with advantages of higher one sided variable flux permanently magnetic stator with no back iron.

The electro-magnetic coils, their coil shape and sequence and the associated magnetic particle cores can be arranged to provide strong reinforcing fields on a chosen face or alignment thus providing a strong one side field flux in a less complex form than that of “Halbach” coil arrays. For the purpose of this invention such a coil array will be called a “V” coil array, and is equally applicable for windings around magnet segments of prior art as it is to the permanently magnetic particle or magnetic particle system of the first embodiment, and can also provide benefits associated with the second embodiment of the present invention as a means of controlling demagnetizing and field weakening. It can also act as a coil array system without a core eg. air core or with conventional soft magnetic core or particle core, in either stator or rotor depending on motor design and type.

As example a permanently magnetic rotor core with like poles corresponding to that of a coaxially wound V coil can have slip rings or an alternative supplying electronically controlled power to the V coils thus optimizing second and third embodiments of the present invention.

A co-axially reinforced permanent magnet rotor or stator in specific circumstances can be particularly useful for vehicles which require lesser magnetic flux at higher speeds and increased flux at lower speed thus allowing the use of less magnetic material since coils reinforce the magnets as required, in one usage of the third embodiment. Optimized flux paths and reduced back iron allows smaller lighter yet potentially more powerful motor/generators.

It should be noted that co-axial coils and drive coils can form part of the structural matrix of a magnetic particle formed component therein reinforcing the structural integrity of the component and binding the coil wires into the component for far greater integrity, made easier by the fact that most soft magnetic particles used for core material utilize particles which are surface insulated.

Coils can also be placed inside a hollow particle core then locked in place by an infill of soft magnetic particles and binder which may be metallic or non metallic resin/plastic binder, said infill further strengthening the magnetic flux generated.

Such coil reinforcement of magnetic material can be well applied to magnetic particles forming a core which may be hollow or solid and having a multitude of shapes also forming part of a component, eg a motor casing or housing, part of which forms the stator “teeth” for example which may contain a high concentration of magnetic material while the outer peripheries utilize primarily matrix material for example aluminium. This could for example be a brushed DC motor with a wound rotor with a coil reinforced magnetic stator. Alternatively a brushless DC or AC motor could utilize a permanent magnet rotor wherein the rotors are formed from magnetic particles in the rotor matrix with specific concentrations and locations to maximize both field strength, field alignment and rotor structural integrity while the rotor could be formed so as to easily accommodate a reinforcing field coil winding, which may then be powered by an electronic control unit via slip rings and brushes, maintaining current in the coils in a direction and strength compatible with the magnetic field in the magnetic poles of the rotor.

This embodiment of the present invention has a number of advantageous characteristics; coils can reinforce the rotor magnets, thus also reinforcing the coercive force of said magnets especially important under high torque or stall conditions wherein magnets may be demagnetized, thus not only improving safe working torque but also increasing usable motor torque and by reducing coil assistance at higher speed reducing magnetic flux and thus reducing back emf and other detrimental flux induced losses thereby increasing motor speed capability, and overall efficiency.

Additionally if heavy duty coils are utilized they can also be used to re-magnetize the rotor magnets or further strengthen the magnets upon machine assembly and creation of more complete flux paths.

Additionally these V coils and their associated cores create a novel coil arrangement with strongly concentrated one sided flux fields, especially so when like poles are arranged in proximity.

A forth embodiment of the present invention combines magnetic particles into arrays that improve magnetic flux concentration.

U.S. Pat. No. 7,352,096 Dunn. et. al. filed Aug. 5, 2005. Electro-motive Machine using Halbach array.

FIG. 11 is interesting in that it shows a Multidisc rotor/stator pack utilizing magnet segments set out in Halbach arrays.

The use of precise electronic pulse control is said to be a primary source of efficiency.

U.S. Pat. No. 6,758,146 Post filed Nov. 27, 2002. Laminated Track Design for Inductrack Maglev System utilizes a magnet configuration comprising a pair of Halbach arrays magnetically and structurally connected.

Both the above patents utilize magnet segments in special Halbach arrays. One embodiment of the present invention replaces the magnet segment arrays of prior art with magnetic particles incorporated and amalgamated into the matrix or structural matrix of a component associated with the prior mentioned Halbach magnet array. The present invention can duplicate the flux arrays created by all prior state of the art magnet segment arrays while greatly easing fabrication and improving structural integrity. A metal matrix material is considered highly suited to such environments since metal is easily bolted into position and is generally more robust than a resin or plastic matrix composite which should be considered an alternative.

In place of a homogenous blend of magnetic particles formed into magnet segments which are then mounted in a holding device which is fixed to a mounting component as is the case with most prior art. The present invention specifically locates, magnetic particles in varying concentrations and flux alignments within the matrix or structural matrix of the component rather than attach a plurality of magnetic segments to the component as is the case with prior art which creates deficiencies in structural integrity, while increasing both component size and weight, said matrix or structural matrix is preferably a metal matrix however a plastic or plastic formed matrix may be suitable under some circumstances.

In addition to simplifying the fabrication of current state of the art magnet arrays by utilizing magnetic particle integration into a component matrix or structural matrix, the present invention also allows the manufacture of unique and novel magnetic combinations which can achieve improved magnetic flux generation and improved interactive capacity with field windings and other magnetic flux.

The second embodiment of the present invention can be applied to improve existing prior art associated with permanent magnet segments or alternatively applied to magnetic particle arrays of the present invention.

As example a conventional Halbach array of permanent magnet segments can utilize a coil wound around for example the primary North and South Pole magnets of the array which are approximately perpendicular to the rotor/stator air gap. The coils are wound in a specific direction and supplied with appropriately directed current to yield a coil field approximately coaxial with and reinforcing the permanent magnet flux. Thus creating a variable flux array with Halbach array benefits which allows a machine higher torque or power output with reduced demagnetization characteristics along with field weakening capabilities on demand by diminishing coil assistance or with care reversing coil flux. Said coaxial flux specifically to allow higher motor torque capacity with reduced possibility of magnet demagnetization along with field weakening as required is unique and novel in the applications associated with the present invention. This principle is even more easily applied to magnetic particles integrated into a components matrix or structural matrix as material shape is easily controlled as is location of magnetic particle concentration and flux alignment. Coils are easily wound around protruding core regions especially formed to accept such coils wherein a very efficient array and associated machine component can be developed. A matrix or structural matrix of metal or fibre reinforced metal is the preferred embodiment, said metal being a non magnetic material with suitable structural load bearing capacity for example, Aluminium, Magnesium, Titanium, Copper, Nickel, Zinc and alloys there of or suitable alternatives, thus forming, a core of magnetic material integrated and amalgamated into said matrix or structural matrix which can also form a primary machine component, for example the case of an electric motor. A plastic matrix or structural matrix formed as example from plastic particles blend with short suitably surface coated reinforcing fibres can also be suitable under certain circumstances eg. low heat low bearing stress circumstances. The V coil array of the third embodiment with or without, magnetic particle core material could be used in place of a Halbach array, and would be ideally suited to interact with the “diagonal” array of the forth embodiment which will be further explained.

U.S. Patent Application 2009/0085412 TAKEUCHI discloses an interesting magnet array and associated drive coils which are an alternative to “Halbach” arrays in creating zones of high magnetic flux concentration, however this array is unlike a “Halbach” array since the disclosed array does not concentrate most magnetic flux on one face. Permanent Magnetic arrays in the form of segments are laid out North to North and South to South, thus are highly “repulsive” and pose assembly difficulties however the interfaces between like poles give rise to highly concentrated flux lines with beneficial results.

A forth embodiment of the present invention achieves the attributes of the above disclosure U.S. Patent Application 2009/0085412 with the attributes of a Halbach array to achieve a “one” face flux with highly concentrated flux line at pole interfaces. The present invention differs significantly from the referenced application by having like poles in proximity on the air gap face and non like N-S poles on the opposite end or face of the magnet array wherein this forms an easy flux return path and minimal “emitted” magnetic fields said fields being concentrated on the face with adjacent like poles N—N, S—S. For the purpose of this present invention this array shall be designated as a “Diagonal” or “V” array. This “Diagonal” array is highly suited to usage with magnetic particle systems of the present invention and allows easy magnetization of components. The basic concept of this array is for poles to align diagonally through a permanently magnetic material either segment or particle concentration wherein like poles meet on diagonal corners of like pole faces being a reinforcing face with high flux concentration and non-like poles meet on the opposing side on diagonal corners of differing pole faces which will have minimal flux concentration. This so named “Diagonal” or “V” array creates a very short flux “return” path at the base of the V where different flux poles (North-South) meet. On this side of the array there is minimal “emitted” flux and said “Diagonal” array closely resembles the “V” coil array of the third embodiment. In both array cases the base of the “V” can be widened into a U shape. However it is the “V” shape which creates the shortest and most efficient flux return path, especially in the case of permanent magnet arrays and magnetic particle arrays. This array is considered unique and novel when used with either magnet particles or permanent magnet segments.

In the case of the magnetic particle systems of this present invention this will present a novel and new magnetic flux array, said array also differs from prior art arrays, of permanent magnet segments. Said Diagonal array can form a V or U shape with the flux “return” path over a minimum distance thus avoiding the use of back iron and the associated inefficiencies.

One sided high flux concentration permanently magnetic particle arrays used in this present invention can be of significant benefit to a number of electro-magnetic machines and magnetic field interaction mechanisms for example magnetic power transfer systems such as that manufactured by “Magnomatics” can greatly ease manufacturing difficulties while significantly improving structural integrity by replacing permanent magnet segments attached to drive components, with permanently magnetic particles suitably located in specific concentrations and specific arrays within the matrix or structural matrix of said drive components. High performance “one” sided magnetic arrays with concentrated flux distributions can also be highly beneficial in such mechanisms whether utilizing magnetic particles or magnet segments.

A number of major automotive manufacturers have introduced hybrid vehicle designs with permanent magnet segments attached to rotational components of transmission components, all of which can benefit from embodiments of the present invention.

Efficient electric motor/generators can gain further efficiency by using frictionless, lubricant free magnetic bearings which function as a result of magnetic interaction to levitate a rotor shaft. Prior art utilize magnet segments attached to both the rotor shaft and the support or casing, such bearings are particularly suited to high speed rotors and also low gravity environments, further stabilization of rotor vibration and oscillation, improved stiffness and damping can be provided by, for example, shorted coils or conductive laminates arranged within the stator which can also house the field winding drive coils.

Eddy currents and resultant deviational force associated with rotor permanent magnets interacting with shorted stator conductors is to some extent self compensating since as lateral movement of the rotor for instance reduces the air gap to the stator, repulsive forces increase thus tending to centralize the rotor.

The incorporation, amalgamation and integration of magnetic particle concentrations within the structural matrix of machine components so as to optimize the magnetic field capabilities while also optimizing the structural load bearing capabilities and thereby forming a material or component that meets the definition of a Synthetic Multifunctional Material is an important aspect of the present invention which separates it from the prior art. It should also be noted that the structural integrity considered necessary for many of the proposed uses of the present invention make the utilization of a metal matrix, metal matrix binder highly desirable. However some specific cases of high strength material suited for specific purpose can utilize non metallic matrix material. For example carbon ceramic material used in automotive and aircraft brake rotors can also be used for other purposes and is extremely heat resistant and strong in compression, Carbon fibre, Boron fibre, and equivalent reinforced plastics can form highly specialized matrix binders and should also be considered useful for some embodiments of the present invention however it is the metal matrix materials which may also be reinforced with suitable fibres which form the primary basis of the present invention.

U.S. Pat. No. 6,806,605 Gabrys Filed May 13, 2002 describes one form of permanent magnet bearing of which there are numerous alternative disclosures. In almost all cases these Patents utilize permanent magnet segments thus in all such cases these systems can be significantly improved by utilization of embodiments of this present invention. U.S. Pat. No. 6,806,605 in the second paragraph of the “Background” clearly states the limitations of attached magnet segments wherein the low tensile strength of rare earth magnets subjected to high centrifugal loadings are prone to failure.

Thus while the above mentioned patent and other patents aim to improve attachment techniques for magnet segments by far the ultimate structural solution is to make the magnetic particles an assimilated and integrated part of the component matrix or structural matrix while specifically controlling location and concentration of magnetic particles and structural matrix material so as to achieve a totally controlled component which can potentially achieve the highest possible structural requirements achievable by the matrix material while also placing magnetic field producing material exactly where it is most efficiently utilized as is achieved by this present invention and bears little similarity to prior art.

Although the present invention has relevance to a wide array of magnetic bearing systems the present disclosure will concentrate on an explanation of the present inventions usage in the type of passive magnetic bearing operating in the passive repulsion mode as described in Reference; NASA/TM-2003-211996/Rev.1 Jan. 2008 Wilfredo Morales and Robert Fusaro, Permanent Magnetic Bearing for Spacecraft Application which describes rotating and stationary arrays of permanent magnets arranged so as to repel each other when the rotating and non-rotating sleeves are axially aligned. Also Referenced; NASA/TM-2008-215056 February, Christopher A. Gallo. Halbach Magnetic Rotor Development. This document describes a Halbach permanent magnet segment array attached to the periphery of a cylindrical rotor for a radial flux machine while an axial flux rotor has permanent magnet segments attached to the face of a disk with segments regularly spaced radially and exhibiting axial flux, in a Halbach array. Embodiments of the present invention can further improve this prior art technology.

It is stated that the field strength of the magnets is a function of the magnetic material density, the clearance between the rotor and stator (the air gap width) and the rotor speed.

The rotors of this second listed experiment are levitated as a result of rotor flux inducing opposing forces in a series of shorted coils in proximity to the rotor field. It is also stated that rotation of the magnetic rotor past the stator coils generates a current and this current creates heat which increases with speed.

A number of observations can be made which are relevant to the benefits of the present invention. It is clear in the case of both NASA experiments that a large amount of effort and a high degree of precision has been associated with fabrication of the permanent magnet arrays, containment and retention of the magnet segments clearly requires precise machining of all components and use of heavy duty retaining rings and plates, and considering the mass of such magnet segments and their radius of rotation it is clear that retention of such segments will be a primary criteria in determining the safe operating speed of the device.

The present invention integrates and amalgamates specific concentrations of magnetic particles in specific locations of a component matrix or structural matrix which in the case of the prior experiment would be radial and axial flux rotors and static regions in the case of a magnet to magnet bearing. The present invention would effectively create a structurally continuous integral component without the plurality of permanent magnet segments, plates, retaining rings and fixtures as used in the experiment and also common practice in the prior art field of fabrication of components.

Magnetic Particles amalgamated and integrated into the structural matrix of a load sustaining metal matrix component and specifically locating said magnetic particles within said metal matrix to maximize suitability of magnetic arrays while also maintaining said matrix material in such structural load bearing alignments so as to maximize structural integrity and is highly efficient in terms of material usage, easily and cost effectively fabricated, heat resistant to a much higher level than resin/plastic matrix binder materials of prior art and much more suited to the environment associated with transport vehicles and in particular hybrid and electric vehicles, which also require cost efficiency and rugged reliability.

It should also be noted that sintered, highly compacted anisotropic/isotropic permanent magnet segments which form the basis of most high performance permanent magnet motors and magnetic drive systems are capable of very high magnetic material density, and that the present invention can, for example, slightly reduce the absolute magnetic material density in many regions due to integration of “component matrix” material interspersed with magnetic particles. This would effectively reduce slightly the overall magnetic flux created by regions of the present invention when compared with that of a “pure” sintered highly compacted rare earth magnet for example. However this is not only offset by the dramatic improvement in structural integrity offered by the present invention but also as a result of this structural integrity, the structurally continuous component produced requires no banding or plate retaining structure. This retaining structure almost always forms an interface between permanent magnet segments for example a rotor and the stator drive section which effectively widens the “air gap”. It should also be noted that magnetic flux interaction falls off exponentially with the widening of the “air gap”. Thus the present invention which requires no banding or retaining structure will allow far more precise control of the effective air gap (which would in prior art include the thickness of the retaining item and any associated run out) resulting in said air gap being greatly reduced by the present invention and flux interaction between for example rotor and stator being significantly increased, more than off setting a small magnet material density reduction when comparing the present magnetic particle invention with permanent magnet segment components.

The present invention lends itself to automated production and creates a magnetic component capable of achieving very close tolerances of manufacture thereby benefitting a wide array of magnetic field interactive machinery since most must maintain close tolerances on air gap width to achieve maximum efficiency.

Inspection of both NASA experiments referenced shows the use of rotor magnetic bearings and static bearings in the case of permanent magnet to permanent magnet interaction wherein these bearings are quite large in both diameter and length when compared with the size of the rotor being levitated or supported. Utilizing the present invention to replace permanent magnet segments attached for example to the outer periphery of a rotor would create a rotor of high structural integrity wherein concentrations of permanently magnetic particles are specifically located and pole directions aligned to suit the chosen magnetic array, “Diagonal” “V” or “Halbach” being highly efficient arrays, internal flux paths are also created by specifically located and aligned permanently magnetic particles while regions of a structural nature which do not require magnetic field influence are composed of structural matrix material. This matrix material can be metallic, non magnetic, for example aluminium , metallic soft magnetic, for instance iron dust, non-metallic for instance carbon fibre composite, carbon ceramic or as example carbon fibre resin/plastic matrix forming a structural matrix material within which concentrations of magnetic particles are suitably located in accordance with principles of claims of U.S. Pat. No. 7,703,717 Soderberg.

It is also important to mention that in the case of magnetic attraction or repulsion the total force applied will be directly related to the total magnetic flux acting over the area of actuation which is important in the case of bearings where stationary magnets and rotating magnets repel each other. In this case both a “Halbach” array and a “Diagonal” array concentrate most flux on one side and both arrays offer a similar total flux and thus similar advantages. However in the case of a magnetic field passing over a conductor, as is the case of levitation coils, sheet laminates, or rotor/stator coils in machines, an induced current in the conductor is dependant upon the overall quantity and strength of magnetic flux passing over the conductor in a certain time and also the intensity of the flux. For example a certain area of magnetic flux producing material having a relatively uniform flux over the total area passes over a conductor in a set time span, another magnetic flux producing material has the same surface area and same total flux however in this instance the flux is highly concentrated in a specific region while the same total area passes over the same conductor in the same space of time the same total flux occurs at just one concentrated point rather than spread over the area and creates a much more rapid interaction with the conductor. This highly concentrated flux has the potential to induce significantly higher currents and thus induced magnetic fields in the conductor due to the more rapid intersection of magnetic flux with conductor.

The Halbach array concentrates most of the total magnetic flux on one side however this flux exits or enters at magnet pole faces over a significant area. In the case of a permanent magnet segment array this would be the North and South Pole faces of the magnets with flux which are approximately perpendicular to the air gap and represent a significant surface area over which flux interacts with a conductor passing over said flux.

By comparison the “Diagonal” “V” array of the forth embodiment of the present invention whether magnetic particle or permanent magnetic segment array concentrates most of the total magnetic flux on one side however the exit and entry flux areas are far more concentrated than that of a Halbach array. All flux in the forth embodiment of the present invention is “funneled” through a more concentrated area which for a certain total magnetic flux results in regions of more abrupt flux peaks than is achieved with the “Halbach” array.

Thus for applications where a rapid rise and fall in peak flux passing through a conductor is critical to the operation of a machine the “Diagonal” “V” magnet array of the forth embodiment of the present invention can be preferable to the “Halbach” array.

U.S. Pat. No. 6,983,701 Thornton et. al. filed Oct. 1, 2003. Describes “Maglev” Vehicles including suspension magnets with co-axial coils to vary levitation forces thereby controlling magnetic gap. These coils are in no way concerned with reducing the possibility of motor magnetic demagnetizing however this alternate use of coaxial acting magnet coils reinforces the viability and effectiveness of the second embodiment of the present invention.

U.S. Pat. No. 6,983,701 describes super-conducting electro-magnets used instead of or in addition to permanent magnets, similar super-conducting elements could easily be utilized in the present invention in place of “conventional” conductors.

This disclosure utilizes magnet attractive forces to achieve levitation, guidance and propulsion of vehicles which is similar in principle to that of attractive magnet bearings which utilize precise electronic control to maintain air gap and stability.

U.S. Pat. No. 6,758,146 Post, filed Nov. 27, 2002 Describes a “Maglev” vehicle with Halbach Permanent Magnet segment Arrays repelled by induced circuits in the track.

Both the “Maglev” disclosures listed above can potentially benefit by using aspects of the present invention, in the form of magnetic particle arrays integrated into a component matrix or structural matrix. Additionally the “diagonal” array of the present inventions forth embodiment can provide benefits as it provides very rapid rise and fall of flux when passing over conductors as is the case with U.S. Pat. No. 6,758,146 Post which can potentially increase induced forces.

U.S. Pat. No. 6,806,605 Gabrys filed May 13, 2002 describes Permanent Magnetic Bearings.

This disclosure and the prior mentioned NASA Magnetic Bearing experiments are typical of the present state of the art, and prior art in the usage of magnet arrays, a similarity exists between the usage of magnet arrays used on all magnetic field interactive type machines and almost all can benefit from the embodiments of the present invention. A variety of different magnetic field interactive machines are described in Patent disclosures referenced all of which can benefit from embodiments of the present invention.

Inspection of Magnomatics magnetic gear and pseudo direct drive as disclosed in European Patents EP2041861 and EP2011215 describes a state of the art torque transfer system with radial field rotor and stator permanent magnet segments.

U.S. Pat. No. 6,440,055 Meisberger filed Aug. 27, 2002 describes a type of magnetic gear again utilizing magnetic segments.

U.S. Pat. No. 7,373,716 Ras filed Oct. 22, 2003 describes a method of containing a permanent magnet assembly.

U.S. Patent Application 2009/0001831 Cho et. al. filed Jan. 1, 2009 discloses a combined axial flux and radial flux permanent magnet electric motor along with prior art references all of which utilize arrays of permanent magnet segment.

All the above listed patents can benefit from replacing magnet segments with embodiments of the present invention.

U.S. Pat. No. 7,663,327 Bhatt filed May 15, 2006 describes a Non-Axisymmetric Periodic Permanent Magnet Focusing System which utilizes an array of permanent magnet segments running the length of the device. Specialized magnet arrays such as Halbach arrays are often utilized in devices of this type. The present invention can ease fabrication of the magnet array and provide more robust equipment while also offering an alternative to the “Halbach” array.

U.S. Pat. No. 4,938,190 McCabe filed May 5, 1989 describes a throttle Plate Actuator for an automobile, with a rotor having permanent magnet segments. Such actuators are now common practice in most new automobiles and can be considered almost essential for hybrid electric vehicles and can be simplified, enhanced structurally and be more suited to mass production by utilizing embodiments of the present invention.

The types of machine, whether AC/DC Brushless, synchronous, reluctance, Interior or Surface Mounted Permanent Magnet Machine, servo-drive, brushed motor, magnetic power transfer machines, linear magnetic drive, levitation machines, is not significant to the basic principles of the present invention, such machines are highly diversified, highly developed as are the power electronics associated with such machines. The present invention and its associated embodiments can be applied to benefit the efficiency, structural integrity, and cost viability of a large array of machines relying on an interaction of magnetic field forces or electro-magnetic field forces.

Aspects of the present invention are suited for usage in virtually all types of electro-magnetic and magnetic drive system for example Brushless AC/DC Motor/Generators otherwise known as electronically commutated motors, Induction Motors, Reluctance motors with Permanent magnets; for example Interior Permanent Magnet (IPM) Machines having both magnetic and reluctance torque, brushed DC motors, linear motors, servo-motors as example, along with magnetic drive transfer machinery “magnetic gearboxes” and so called pseudo direct drive motor/generators, magnetic levitation systems, magnetic bearings, magnetic propulsion systems and material accelerators, all can benefit from aspects of this present disclosure and all such systems have well developed designs, fabrication methods and electronic control units, all of which are easily accessible to those skilled in the art.

The electronic control units, microprocessors, drive units, batteries, capacitors, electrical circuitry, structural materials, magnetic particles and materials technology, components and relevant technology and know how are widely available in the market place which includes a vast array of constantly improving technology which can be directly applied to manufacture and operate the present invention.

As example it is well known within the current state of the art to induce torque or translational forces within a conductive body for example; a copper wire, or an aluminium sheathed object by imposing upon said conductive body a changing electro-magnetic or magnetic field. However since one embodiment of the present invention incorporates, amalgamates and integrates magnetic particles, being at least one of; permanently magnetic particles, particles which become magnetic under the influence of a magnetic field for example soft magnetic particles of iron dust, sendust, or permalloy, alternatively such particles may be of conductive material for example aluminium or copper which when formed into concentrated “clusters” within a components matrix or structural matrix can under the influence of a primary magnetic field give rise to secondary induced magnetic fields and interact with the primary magnetic field. As example consider a non magnetic, non conductive object or machine component such as a composite or ceramic disk, said disk could house within its matrix or structural matrix concentrations of specifically located particles being at least one of or a combination of; magnetic particles, soft magnetic particles, electrically conductive particles.

The object or machine component which may be a disk defined as a secondary component can be “driven” by magnetic field forces associated with appropriately designed, located, controlled, and arranged primary field coils of a primary component which react with at least one of; induced field forces within the secondary component or alternatively a combination of reluctance and magnetic forces created within soft magnetic material and magnetic material associated with the secondary component magnetic field forces created by permanently magnetic material within the secondary component. Such a disk could form a high speed rotor operating in a vacuum and incorporating “magnetic bearings” utilizing embodiments of the present invention and acting as, for example, a flywheel energy storage device which either acts as a unit or as a combined energy storage system in combination with capacitors and or batteries to store energy for progressive usage while also being capable of storage and delivery of rapid “bursts” of energy, a device highly suited to high performance hybrid and electric vehicles. This same principle can also be applied to linear drive and accelerative drive machines wherein conductive “jackets” are replaced by integrated magnetic particles and or conductive particles within an objects or components surface or internal matrix the advantage is to allow the designer far greater control of induced fields and or magnetic fields which react with the drive system since an infinite array of particle combinations, concentrations, and field alignments can be achieved thus potentially greatly improving efficiency beyond that of the more restrictive conductive “ jacket”. One type of machine utilizing such principle is referred to as a co-axial accelerator.

The intention of the present invention is to make use of existing and future developments and advances in the theory and principles of electric drive mechanisms, present and future technology in conductor materials and super-conductors, present and future technology in the field of permanent magnets and magnetic drive transfer systems, present and future technology in magnetic particle and magnet particle core materials and soft magnetic material, present and future developments and technology in metal matrix composites, present and future technology in metal fabrication, forming, casting and powder metallurgy, and present and future technology in the field of electric conductor materials and super conductors which give rise to strong magnetic field forces along with electrical control units and microprocessors. All of this technology is available in the market place and components of the technology necessary to manufacture the present invention are easily available with improvements in materials and technology continually coming onto the market.

The present invention makes use of existing electric and magnetic drive system theory and component technology and arranges these components and constituents thereof so as to form new and unique devices which can be easily manufactured by persons skilled in the art and can make use of both present and future materials and technology to upgrade and improve the efficiency of the invention while maintaining the basic mode and principles of operation of the present invention.

For the purposes of this disclosure we shall define a “Multifunctional” material or component as having a structural form and a matrix composed in part of magnetic field producing medium. Said “Multifunctional” material can also define a “Synthetic Multifunctional Material” as per the definition provided in U.S. Pat. No. 7,703,717 Soderberg. In sections of the specification it is stated that magnetic material which includes for example sintered magnetic material, bonded magnetic material, soft magnetic material and electrically conductive materials which become magnetic under the influence of an electric or magnetic field can be formed into complex shapes and or arrangements and that it is possible to incorporate, amalgamate and assimilate these materials into the matrix or structural matrix of components. Such materials possess structural capability plus power/energy generation capabilities and are materials designed and processed to provide multiple performance capabilities in a single material system of controlled architecture. Such a materials system bears mechanical loads or resists superimposed mechanical stresses in service while providing at least one additional non-structural function for example, the creation of magnetic field forces, for the purposes of this present invention material/components so formed shall be referred to as “Multifunctional”. Magnetic Particles incorporated within the structural matrix or matrix of a component meets the definition of a “Multifunctional” Material, as do conductive elements incorporated into a component structure wherein said component structure forms the dual role of a machine component, for example a machine housing a flywheel, wheel rim or brake rotor disk, serves the structural requirements of the component, while also creating magnetic or electro-magnetic field forces, wherein said components incorporate magnetic field producing material or magnetic field interactive elements.

For the purpose of this disclosure and to avoid misunderstanding “Matrix” of a component shall be defined as a continuous solid phase in which particles are embedded, as example, iron forms the matrix of a steel component as does cement in a concrete component.

Also for the purposes of this disclosure “Structural Matrix” of a component should be considered to define the engineering sense wherein magnetic field producing material including magnetic particles or magnetic field producing elements are specifically designed distributed and configured to allow formation of structural load bearing elements within a load bearing component. “Structural Matrix” of a component relates to a structural load bearing material which forms the matrix of a material or component wherein incorporation and integration of magnetic field producing material thereby retains or enhances the structural integrity of the matrix. Structure infers strength and integrity characteristics of the component which differs totally from the generalized definition of a structure which generally means a combination of components for example. something constructed.

The provisional specification claimed as a priority document should be referred to as this document describes a wide range of different methods for incorporating magnetic interactive drive components into vehicle and other machine drive systems.

It should also be noted that not all magnetic field interactive components claimed as novel to the present invention need be composed strictly of particles and matrix, in many cases magnetic segments or magnetically interactive “solid” components can also form novel and inventive solutions while maintaining commercial worth. For example an aluminium or copper “squirrel cage” in the shape of a ladder ring can be housed within for example a non-magnetic, non conductive carbon/epoxy, composite wheel rim, which when acted on by a varying electromagnetic field can give rise to an induced magnetic field with the “squirrel cage” bound into the wheel rim. The cage could alternatively be formed of particles of conductive material. Regions inside each of the closed loops of the “squired cage” could contain soft magnetic particles acting as a core material. Alternatively magnetic particles and primarily permanently magnetic particles in a suitable magnetic array could replace the “squirrel cage” thereby acting as a brushless permanent magnetic motor/generator rather than an induction or reluctance type motor/generator.

For the purpose of this disclosure and to avoid confusion in claims, a “Magnetic field interactive” mechanism or machines shall define, an apparatus, tool, device, appliance, machine or mechanism or component thereof , wherein magnetic field forces and or electro-magnetic field forces interact to achieve a predetermined result, this could be a simple wire loop or, this could be a passive machine such as a magnetic bearing acting in repulsion mode with opposing field magnetic bearing surfaces, a levitating bearing rotor or levitating vehicle wherein a moving permanently magnetic array induces opposing (levitating) forces in a “ static” conductor or an active machine such as an active, magnetic bearing or levitating vehicle acting in “attraction” mode to achieve levitation with precise electronic control between magnetic material and electro-magnetic forces.

A similar active system exists in many rotational machines wherein magnetic material, either permanently magnetic material, soft magnetic material, electrically conductive material or a combination of these interact with primary electro-magnetic fields which are generally precisely controlled. Radial Gap and axial gap motor/generators, Pseudo direct drive motor/generators are also actively controlled “magnetically interactive” mechanisms, while “magnetic gear boxes” and magnetic power transfer machines are primarily passive “magnetically interactive” mechanisms.

Mechanism shall for the purposes of this disclosure define, a device, an instrument, an apparatus, a machine, a tool an appliance and not the alternative meaning of a means or method.

It should be noted that integrating magnetic particles into the periphery of for example a rotor matrix wherein the interior matrix is a continuous matrix phase of for instance aluminium and the periphery amalgamates a distribution of magnetic particles within the same aluminium matrix material to form a composite structure differing in magnetic particle concentration radially from the central axis while providing an approximately uniform concentration of magnetic particles at a specific radial distance from the central axis with said concentration approximately evenly distributed throughout the axial length and radial perimeter at a specific radial distance from the axis therein providing a uniquely different mechanism to that of prior art formed to shape solid magnets, wherein magnet rings form a totally separate, entity to that of the item to which the homogeneous ring is attached or strip of homogeneous magnet material bonded to an item.

Thus the present invention forms a composite amalgamated item which can form a homogeneous blend of magnetic particles within a matrix material in one or more three dimensional axis while forming a specific non homogeneous magnetic particle distribution within said matrix in at least one other three dimensional axis.

For instance a passive magnetic bearing could contain within its interactive cylindrical surface far example, circular bands of like poled magnetic particle on the rotor shaft forming North/South rings amalgamated into the shaft matrix which oppose adjacent circular bands of like poles forming North/South rings on the static section of the bearing amalgamated into specific locations of said bearing.

Alternatively another passive magnetic bearing would interact with shorted inductive conductors of the static component while the rotor shaft section would for example contain lines of magnetic particles aligned in North/South arrays approximated parallel to the shaft axis thereby creating magnetic flux lines with alternating poles cutting the shorted conductor of the static component. These same principles can be applied to levitating machine rotors and other levitational mechanisms and “Maglev” vehicles.

### SUMMARY OF THE INVENTION

It is a primary object of the present invention to provide significantly improved magnetic field interactive machines or mechanisms by integrating, amalgamating and specifically locating and concentrating magnetic field producing medium which give rise to magnetic fields within the matrix or structural matrix of magnetic field interactive components of said machines so as to create a component with improved structural and mechanical capacity when compared with the prior art while also being capable of producing precise magnetic field forces, flux and pole alignments as required by the designer.

It is envisaged that most Permanent Magnet Machines plus a large proportion of magnetic field interactive machines and electro-magnetic field interactive machines can benefit significantly from utilization of embodiments of the present invention.

Permanent Magnet electric motor/generators, tools and machinery incorporating interactive magnetic and electro-magnetic fields will benefit significantly. Of particular interest are Hybrid and electrically motivated vehicles including Hydrogen Fuel Cell electric vehicles, alternative fuel vehicles incorporating electric motors, and the wide array of equipment utilizing magnetic field interaction associated with such vehicles the total system of which must be efficient in terms of both electric power usage and fuel usage, ultimately all electro-magnetic drive systems and motors and interactive magnetic drive systems must be small, light weight, structurally of high integrity and offer a long service life while being cost efficient, and easily mass produced, criteria which are successfully addressed by the present invention and are lacking in the prior art especially in the field of structural integrity, robustness, and the case of manufacture and suitability for mass production. U.S. Pat. No. 6,806,605 Gabrys specifically points out the structural integrity deficiencies associated with attached magnet segments especially where high rotational speeds are involved.

A primary embodiment of the present invention incorporates and integrates magnetic particles into the matrix or structural matrix of a component which is comprised of a matrix material and specifically located concentrations of magnetic particles thereby creating magnetic fields with specific flux concentrations and pole alignment forming magnetic field arrays within said component which forms part of a magnetic field interactive machine which “functions” as a result of magnetic field interaction. Said magnetic field can be created as example by permanently magnetic material, electrical current flow within a conductor, induced in a soft magnetic material by a magnetic field or created in a conductive element by a changing magnetic field.

The first embodiment of the present invention utilizes magnetic particles, being either permanently magnetic particles, or soft magnetic particles which become magnetic under the influence of a magnetic field, including electrically conductive particles, with specific particle concentrations in specific regions of a component. These magnetic particles specifically concentrated in regions of a component matrix can be utilized in numerous machines in place of permanent magnet segments or a formed to shape magnet with significant prior mentioned advantages.

It should also be noted that the prior art fails to disclose or make obvious machine components wherein a magnetic field force is provided by a material comprising magnetic particles that are specifically concentrated in specific locations within regions of a component matrix wherein said magnetic particles become an integral, amalgamated part of the component matrix or structural matrix in specific predetermined locations requiring magnetic field interaction while regions outside this location contain primarily matrix material. The whole integral component can thereby be designed to meet the highest structural capabilities of the chosen matrix material while also possessing a magnetic field interactive capability combined within a single materials system of controlled architecture. For the purposes of the present disclosure such a component or materials system shall be defined as “Multifunctional”, and meets the definition provided in U.S. Pat. No. 7,703,717 Soderberg of a “Synthetic Multifunctional Material”.

The second embodiment of the present invention discloses a method of improving low and medium speed magnetic field characteristics of a machine while also reducing the potential for demagnetizing of permanent magnet machines. The method utilized also allows field weakening at higher speeds thus improving efficiency of machines which suffer back emf effects at higher speeds. In this second embodiment an electric current energized coil applies coaxial fields to a magnetic core, said coil can be co-axially wound with the core or act remotely. Control is straight forward, there being coordination between the drive coils and the “anti-demagnetizing” reinforcing coils as drive coil flux increases so does the reinforcing coil flux with motor characteristics known demagnetizing is avoided.

The second embodiment utilizes field winding coils to apply an approximately co-axial magnetic flux to a magnetic core which may be either a “conventional” permanent magnet segment or magnetic particles; being at least one of; permanently magnetic particles, soft magnetic particles, electrically conductive particles or a combination of these particles, wherein said magnetic core will have an approximately coaxial magnetic pole flux which is reinforced by the coil flux. Reducing or reversing the coil flux weakens the effective core magnetic flux thus allowing a variable field control which for example can strengthen a magnetic rotors effective flux at stall, or when high torque is required improving torque while reducing the likelihood of demagnetizing a permanently magnetic core at this torque, and weaken the rotor flux at high speed to reduce back emf at higher speeds. It should be noted that the magnetic flux in the core material is a result of the type of motor configuration. Said magnetic flux in the core could originate from anyone of; a permanently magnetic core, a soft magnetic core with reluctance type magnetic field due to interaction with a source of magnetic field, or an electrically conductive core design acting in an induction form due to interaction with a variable magnetic field. In all forms precise motor drive control by electric controller/micro-controller is highly desirable specific permanent magnet arrays can have several magnets of the arrays coil reinforced to thereby provide a variable flux array. For example a “Halbach”array can have the primary magnet segments perpendicular to the air gap reinforced with co-axial coils or remotely applied flux.

A DC. machine with wound rotor core can replace commutators with slip rings and electronic control thus allowing precise variable control of rotor magnetic field to correspond with permanent magnetic field of a Stator which may additionally be coil reinforced wherein said reinforcing coils are linked to the same control as the rotor winding allowing increased rotor torque without demagnetizing stator permanently magnetic field.

A third embodiment of the present invention utilizes “V” coils wound around an appropriately shaped “V” core comprised of at least one of; magnetic particles as described in the first embodiment, said magnetic particles integrated within component matrix material, conventional core material for example laminations of silicon steel including an air core to achieve a highly efficient one sided coil flux array for use in for example rotational and linear drive machines, wherein high flux concentrations and potential elimination of back iron can reduce losses, reduce size and weight of a machine while improving performance.

The “V” coils when combined in a series with like poles adjacent to one another creates a series of concentrated, one sided flux of high density.

Advantages of the “V” coil array include increased magnetic flux at the air gap and thus the potential to increase gap widths in harsh environments. The “V” coil array with like poles adjacent to each other eg. North/North, South/South, potentially create sharper more densely concentrated flux arrays at the pole locations as defined in U.S. Patent Application 2009/0085412 Takeuchi previously referenced, however unlike the Takeuchi array the “V” coil array also concentrates most flux to one chosen side thereby increasing efficiency. The combination of highly localize flux concentrations and confinement of a major proportion of total flux to the air gap face can be highly beneficial to a large proportion of rotational and lineal drive machines since flux density flux concentration in specific regions and total magnetic flux are primary criteria governing the design of most machines that function as a result of magnetic and or electro-magnetic field interaction.

A highly efficient machine can be created by matching flux density of the “V” coil with that of a permanently magnetic array, induced array, or a similar electro-magnetic coil array.

A forth embodiment of the present invention utilizes a “Diagonal” or “V” array of either permanent magnet segments or magnetic particles to create an array which applies a large proportion of the total magnetic flux on one side, the interactive “air gap” side, while additionally creating high flux concentrations eminating from the like pole interfaces, thus possessing advantages of rapid flux rise and fall, which is an important feature for machines functioning as a result of interaction between primary or first and secondary or second magnetic fields. As example a rotary machine can potentially develop greater torque with less potential for demagnetizing as a result of utilizing this high flux density “Diagonal” array of the forth embodiment of the present invention.

It should also be noted that although both the third and forth embodiments of the present invention are suitable for interaction with numerous other magnetic field arrays and electro-magnetic field arrangements, the “V” coil array interacting with the “Diagonal” magnetic field array will provide a high concentration of interacting opposing or attracting magnetic flux lines thus a more powerful, higher torque machine with potential to widen the “air gap” under certain circumstance while being highly efficient in terms of power usage.

A number of patents are referenced which utilize “Halbach” arrays for example US 2010/0066192 Yamashita et.al and most can utilize embodiments of the present invention, either in association with the “Halbach” array as with the first and second embodiments of the present invention, or by utilizing the third and forth embodiments in place of “Halbach” arrays.

The above referenced application is also to be noted in the use of “homogeneous” magnetic structures which differ from the present invention. In accordance with embodiments of this disclosure a wide array of magnetic and electro-magnetic driven machines can benefit. Precise control can allow coil arrays to induce opposing or attractive magnetic fields when interacting with magnetic arrays resulting from magnetic particles or prior art magnetic segments and formed to shape magnets.

The present invention can utilize prior art knowledge in creating new and novel machines and all patents referenced are included by reference in their entirety. Prior arts magnetic arrays can utilize or be replaced with embodiments of the present invention. Magnetic segments and machine components such as rotors comprised of formed to shape magnetic material can be replaced with magnetic particle systems and utilize components of the present invention embodiments while utilizing modes of operation of the prior art creating new and versatile machines.

As explained in previously referenced U.S. Pat. No. 7,598,646 drive coils utilizing “Halbach” arrays interacting with permanent magnet segment “Halbach” arrays, it is possible to achieve both drive and levitation functions, such functions are also achievable utilising magnetic particles of the first embodiment, drive coils of the third embodiment and magnetic arrays of the forth embodiment of the present invention, while torque can be improved, high speed operation made more efficient and the possibility of demagnetizing reduced by utilizing the second embodiment in relation to magnetic material.

It should be noted that U.S. Pat. No. 7,703,717 Soderberg which is a continuation of U.S. Pat. No. 7,594,626 filed Jun. 8, 2006 by the same inventor as the present invention introduces a number of Transport Vehicle oriented drive mechanisms which can utilize embodiments of the present invention.

The concept of incorporating and integrating into the matrix or structural matrix of components of a vehicle or drive mechanism magnetic and electro-magnetic field creating elements is considered to be an important concept which can be utilized by embodiments of the present invention to create new and novel machine designs which greatly improve component integrity over that of prior art methods.

A wide array of motor types can benefit which include radial direction gap type motors, axial direction gap type motors, linear drive perpendicular gap type motors, plus numerous variations of the above. Additionally both passive magnetic systems, for example, motor bearings, magnetic power transfer equipment such as magnetic gear boxes, or frictionless castor wheel/spheres acting in passive repulsion mode, or inductive systems such as levitating bearings with permanently magnetic material interacting with inductive material, levitating vehicles such as “Inductrack”; active magnetic controlled levitation such as magnetic bearings in the “attractive mode”, and levitating vehicles working in the “attractive mode” such as some “Maglev” vehicles and linear motion vehicles, material and particle accelerators in fact almost all machinery and equipment which functions as a result of magnetic and or electro-magnetic interaction can utilize aspects of the present invention to achieve significantly improved operation and integrity. Incorporating, integrating and amalgamating field producing elements whether electrically conductive, magnetically soft or permanently magnetic in the form of solid or particle materials specifically located and concentrated; to optimize magnetic, electro-magnetic and structural integrity ; within the matrix or structural matrix of a material or component creates a Novel and new “Multifunctional” material/component which in many circumstances has far superior characteristics to that of the prior art. Method of manufacture and fabrication of the present invention are to be found in present technology and are accessible to those skilled in the art.

U.S. Patent Application 20100019587 Sato et.al Radial Anisotropic Sintered Magnet, and its production method, Magnet Rotor using Sintered Magnet and Magnet using Magnet Rotor.

The present invention makes use of current technology in the art of permanent magnet particle and magnet manufacture.

Application 20100019587 describes a method of producing anistropic magnetic particles, compacting and sintering them into a solid form. Anisotropic permanent magnetic particles are favored in the present invention for their ability to generally create higher flux field density than isotropic particles however where complex magnetizing fields are involved the present invention can utilize either anisotropic or isotropic material. The magnet produced in the above patent application forms an approximately uniform blend of permanently magnetic particles which can be formed to shape to create a rotor of the same uniform blend of permanently magnetic particles. It is a formed to shape magnetic which differs greatly from the present invention which specifically concentrates magnetic particles, in specific regions with specific field alignment within the matrix or structural matrix of a component whose matrix is of a different material to that of the concentrated permanently magnetic material. The “binder” or “coating” of the magnetic particles utilized with the present invention is compatible with the matrix of the component allowing amalgamation of magnetic particles, over a gradation of concentrations, within the matrix of said component.

Prior art methods of producing magnetic material, forming and consolidating material are utilized by the present invention such as method involved in Patent Application 20100019587 wherein anistropic magnet powder, compaction, magnetization, sintering and avoiding cracking can be utilized in the manufacture of the present invention.

U.S. Patent Application 201000079015 Hoshina et al. Dust core, method for producing the same, electric motor, and reactor. Describes methods of forming, soft magnetic powder such as iron powder which can take the place of steel laminations in motor core both motor and or stators. Materials and some procedures can be utilized in the present invention, for example soft magnetic material used in “V” coil assemblies and as field strengthening in association with permanently magnetic particle arrays. Highlighted are methods of pre-coating the soft magnetic particles to insulate particles and also improve compatibility with the binder material which may be resin powder, resin being silicon, epoxy, polyester polymide in powder form while the magnetic particle insulation coating as silica, nitride film and ceramic material as example.

Other methods of forming iron particle cores can use melted plastic and centrifugal molding to achieve high density plastic bonded iron powder cores which can take the place of conventional laminate cores. The same principles can be utilized to incorporate permanently magnetic particles into a plastic matrix U.S. Patent Application 20080260564 Komuro. Compacted Magnetic Core, Production Method of Same, and Motor for Electric Vehicle. This application aims to improve core resistivity and reduce core losses principles of this and other applications can be used to form magnetic particle components for the present invention. There are numerous methods associated with applying multiple coatings to soft magnetic particles, permanently magnetic particles and electrically conductive particles wherein said magnetic particles can be insulative or conductive relative to one another and a base matrix which can be metallic or non-metallic. Particle Metallurgical techniques and

Metal Matrix Composite techniques and technology lend themselves to fabrication into suitable component form wherein integration of magnetic particles and matrix particles along with specially coated reinforcing fibres can produce an integrated component structure of high integrity which possesses magnetic field interactive capabilities.

### DESCRIPTION OF THE DRAWINGS

FIG. 1A Shows a prior art drawing by Mallinson which depicts differing pole alignments within a permanently magnetic material which result in a concentration of magnetic flux primarily on one side of the material. From this origin the “Halbach” magnet array of FIG. 1B. resulted.

FIG. 1C Applies the first embodiment of the present invention to a “Halbach” magnetic field array wherein magnetic particles are specifically located in concentrations within the matrix of another material being either a metal matrix material or in some specific cases a non-metallic matrix. Said magnetic particles being specifically located, aligned and magnetized to form a non homogeneous integration of magnetic particles and matrix material which exhibits a primarily one sided flux array of “Halbach” design. Item 1 depicts a permanent magnetic segment and shows the direction of pole alignment with North pole of the magnet at the head of the arrow.

Item 2 depicts a similar pole alignment resulting from an integrated, specifically located concentration of magnetic particles within a component the matrix of which differs from that of the magnetic particles.

Item 3 represents a region of the component comprised predominantly of matrix material.

FIG. 1D shows a more efficient “Halbach” array of magnetic segments, item 4 giving rise to magnetic flux which in this example interact with a track of transposed conductors, item 5 forming the basis of an inductive levitating “Maglev” transport vehicle.

FIG. 1E utilizes the first embodiment of the present invention to create a similar “Halbach” array which for example can be a non homogeneous amalgamation of specifically located concentrations of magnetic particles within a metal matrix forming a structurally integrated component which is easily formed to a specific shape and can be for example simply bolted or otherwise fastened into position on a vehicle or machine. This has application to Maglev vehicles which function in a purely passive repulsion mode due to induction in track item 6, or in an attraction mode in combination with “control coils”. Such an integrated Distributed Magnetic Metal Matrix Composite material has numerous uses some of which are described to show the principle associated with the present invention, which range from linear drive systems, material accelerators, motor drive systems to particle and light focusing systems.

FIG. 2A depicts an alternative magnetic array to that of the “Halbach” array, and constitutes the forth embodiment of the present invention, which is described as a “Diaonal” or “V” array or “Diagonal V” array. This array is less complex than the “Halbach” array and is easier to assemble and easier to magnetize. It offers a similar one sided reinforcing flux while the array also acts as a “back flux” or return flux path negating the necessity for back iron. Additionally the reinforcing face places like poles, North-North, South-South, in close proximity thereby creating regions of highly concentrated flux which can be highly beneficial to interaction with a conductive material passing through such field, for example a motor coil winding or an inductive track of transposed conductors as described in a “Maglev” passive system. The more rapid rise and fall of magnetic flux, when compared with the “Halbach” array which has flux spread over a greater pole area, can be beneficial in having greater effect on moving particle systems including light and particle systems and having particular usage in permanent magnet motor drive, and magnetic power transfer systems which have significant potential usage in Hybrid and Electric Vehicles.

FIG. 2B Shows a similar “Diagonal V” array utilizing the first embodiment of the present invention wherein magnetic particles, being in this instance permanently magnetic particles, are amalgamated and integrated into the matrix or structural matrix of an item being a material or component such that particle concentrations are specifically located to form a non-homogeneous composition of magnetic particles and matrix material with consideration being given to magnetic field requirements and array formation along with the structural requirements and structural integrity of the component so formed.

Item 2 represents magnetic particles bound within a matrix material, while item 3 defines primarily matrix material. The Distributed Magnetic Metal Matrix Composite material so formed can form part of a component, for example, a ring or band around the circumference of a cylindrical rotor, or an attachment to a wheel rim, or alternatively it can form part of the matrix or structural matrix of the component, for example, the rotor or wheel rim can integrate magnetic particles into specifically located distributions within said component.

FIG. 2C and FIG. 2D Depict rare earth magnet rod arrays forming both a “Halbach” array and a “Diagonal V” array performed as a test described in the later section of the “Preferred Embodiments of the Present Invention” utilizing equal amounts of magnetic material in arrays of “identical” magnetic rods, 5 for each array. The easily performed test which was highly repeatable in terms of results showed the “Diagonal V” array to be significantly stronger on the reinforcing side than was the case with this particular “Halbach” array. It should be noted that in the case of both arrays the use of separate magnet segments creates far from perfect continuity of “back face” or return flux on the non reinforcing flux side. None the less the use of magnet segments is common practise in industry, thus making such a test quite relevant. Usage of fully integrated magnetic particle system as disclosed in the first embodiment of the present invention can be highly beneficial to both the described arrays and most other commonly utilized magnet arrays as inter-magnetic particle connection can be complete with no “air gaps” what ever on the “internal” flux path, the only “open” flux being on the working or interactive flux “air gap” reinforcing face.

FIG. 2E Depicts a prior art “Halbach” coil array which in the case of the referenced US Patent claiming said array is formed by an array of separate coils with pole alignments mirroring those of a “Halbach” magnet segment array, therein possessing similar advantageous characteristics typified by the “Halbach” array.

FIG. 2F Depicts a “V” coil array characteristic of the third embodiment of the present invention. Said “V” coil array can be formed from separate coils with like poles in proximity on the reinforcing side and non like poles in proximity on the non reinforcing side. Alternatively there can be a continuity of the conductor wire between coils forming “legs” of the “V” while power to the combined “V” coils can be supplied in a wide range of sequences depending on the type of drive system being fabricated. It is important that pole alignment be kept in mind as the reinforcing effect comes from the proximity of like poles while continuity of “back face” flux, elimination of back iron, and minimizing loses results from non like poles in proximity and a flux flow path being created at the base or point of the “V”, a situation clearly depicted in FIG. 2H.

FIG. 2G Depicts a co-axial reinforcing coil arrangement for a permanent magnet array specifically utilized to reduce the chance of permanent magnet demagnetization,which can ocure when said magnet is exposed to an external opposing magnetic field as can be the case in numerous motor drive systems.

In this example a “Halbach” permanently magnetic particle array is formed utilizing embodiments of the present invention, to create an integrated system. However separate magnet segments could also serve the purpose albeit with some loss of efficiency. In this case the “primary” North-South pole arrays which form the reinforcing poles are approximately perpendicular to a “working” air gap and are wound with co-axial coils or have remotely acting coils with field connection to the magnet arrays such that the coil poles reinforce the permanent magnet poles therein allowing the motor or mechanism to for example apply higher load or torque under, as example, low speed or stall conditions while maintaining the magnetic core above magnet coercive strength and therein avoiding demagnetization when under an opposing magnetic field which would otherwise create demagnetizing problems. Additional benefit can come for example in a rotational permanent magnet rotor motor with coil wound rotor poles provided with electronically controlled power via slip rings for example, wherein as motor speed increases reinforcing effect of the co-axially interacting coils can be diminished and even moderately reversed, with care, thereby allowing rotor magnetic flux reduction as required thus reducing back emf in the stator drive coils and improving motor efficiency therein creating an electronically controlled system which improves motor torque while also reducing the risk of demagnetization and allows field weakening with speed. Slip rings are a minor inefficiency when compared with the gains achieved. Additionally a remote supply of magnetic flux to the rotor is a possible method of avoiding slip ring usage.

The reinforcing co-axial coils can also be designed to improve magnetization of magnetic material after motor assembly or to re-magnetize an accidentally partially demagnetized magnetic material.

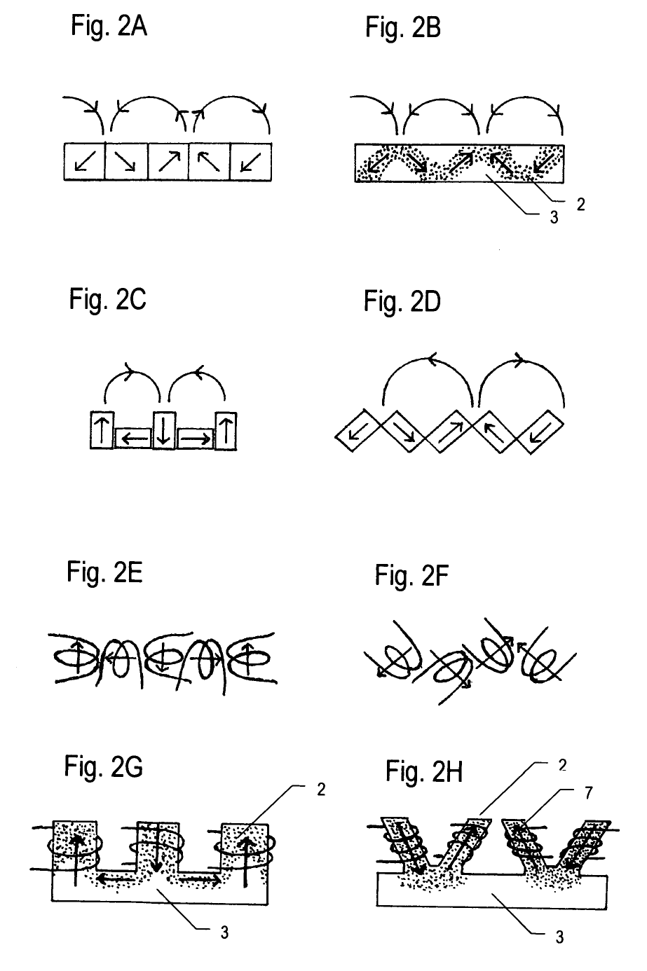

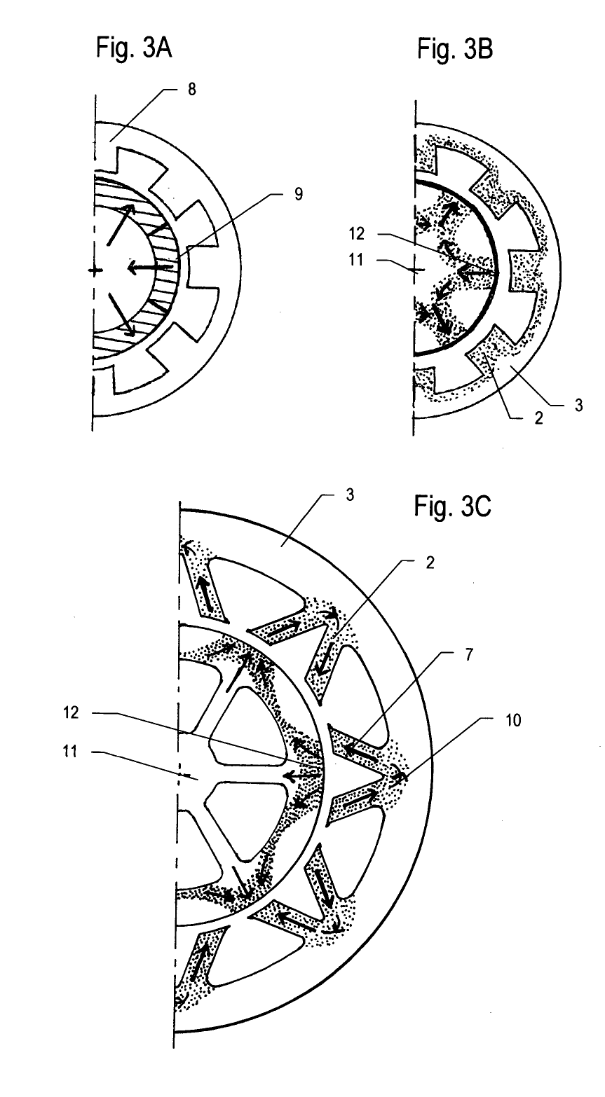

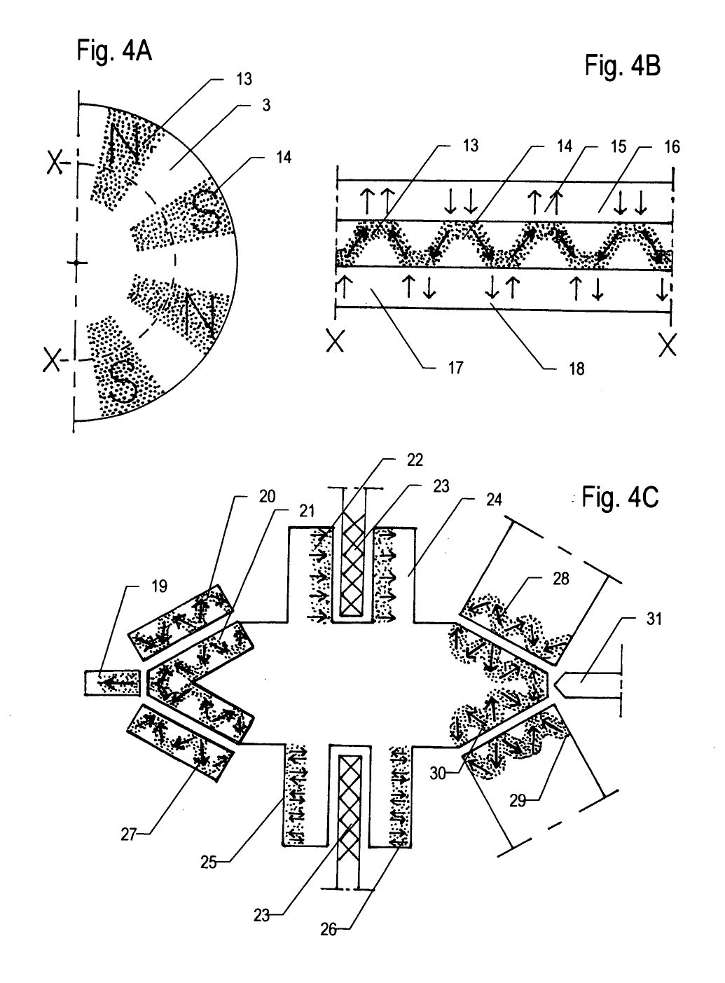

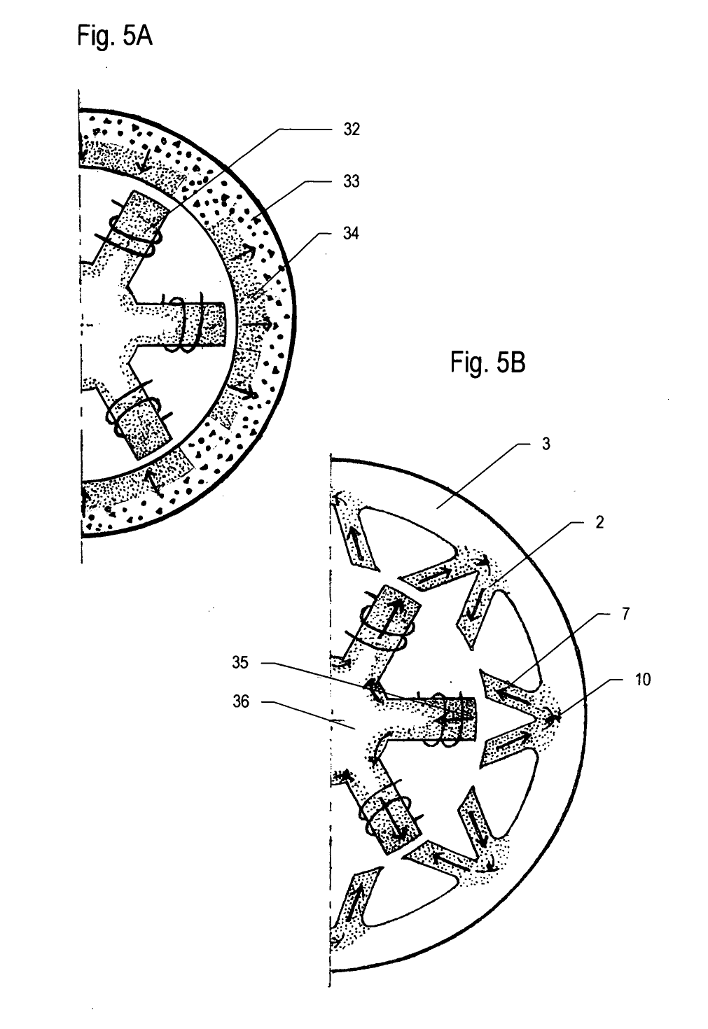

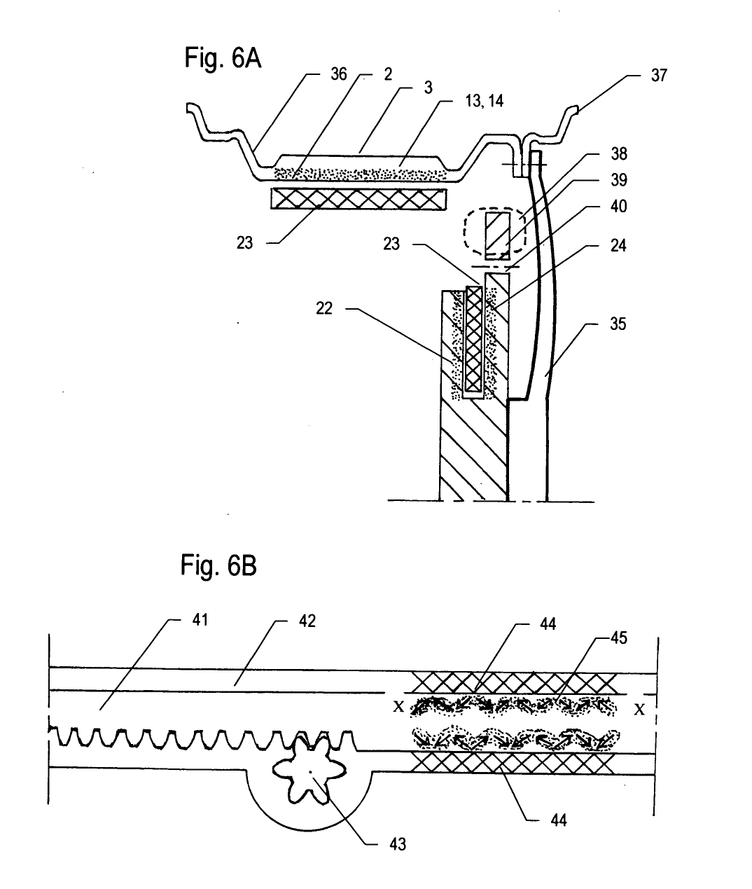

FIG. 2H Can be considered representative of a number of embodiments of the present invention. The first embodiment incorporates specifically located magnetic particles within a matrix or structural matrix of a material forming a non-homogeneous amalgamation of magnetic particles which for example can be permanently magnetic particles, soft magnetic particles, electrically conductive particles or a combination there of.

If we consider the particles in FIG. 2H item 7 to be permanently magnetic particles then this drawing could for example represent a section of a permanent magnet machine rotor with “Diagonal V” arrays of magnetic particles co-axially reinforced by “V” coil arrays to achieve a high torque machine with demagnetizing protection and field weakening capabilities with a highly efficient rotor configuration with a maximized one sided (air gap side) flux concentrations, highly concentrated flux at the poles and no requirement for back iron, thus allowing freedom in the material choice for the rotor and particle matrix which is integrated with the rotor matrix.

Alternatively if we consider the magnetic particles to be soft magnetic particles integrated into a matrix of for example a highly structural material such as aluminium alloy suitable alternatives and alloys there of, or fibre reinforced composite item 3 in this example, can form a combined stator and machine casing while the stator is an amalgamated and integrated soft magnetic particle array formed into a “V” core with “V” coil winding in a formation where the air gap region has like poles of the “V” in close proximity and in proximity to the air gap and rotor while the base or point of the “V” is integrated into the matrix or structural matrix of the casing material and forms the Non Like Pole region of the flux return path thus eliminating the need for back iron and also creating a very short flux return path which improves motor efficiency while the “V” coil, “V” core formation maximizes one sided flux on the air gap side in the same way as does the “Diagonal V” magnet array. “V” coils adjacent to the air gap have like poles in proximity in order to maximize flux efficiency.

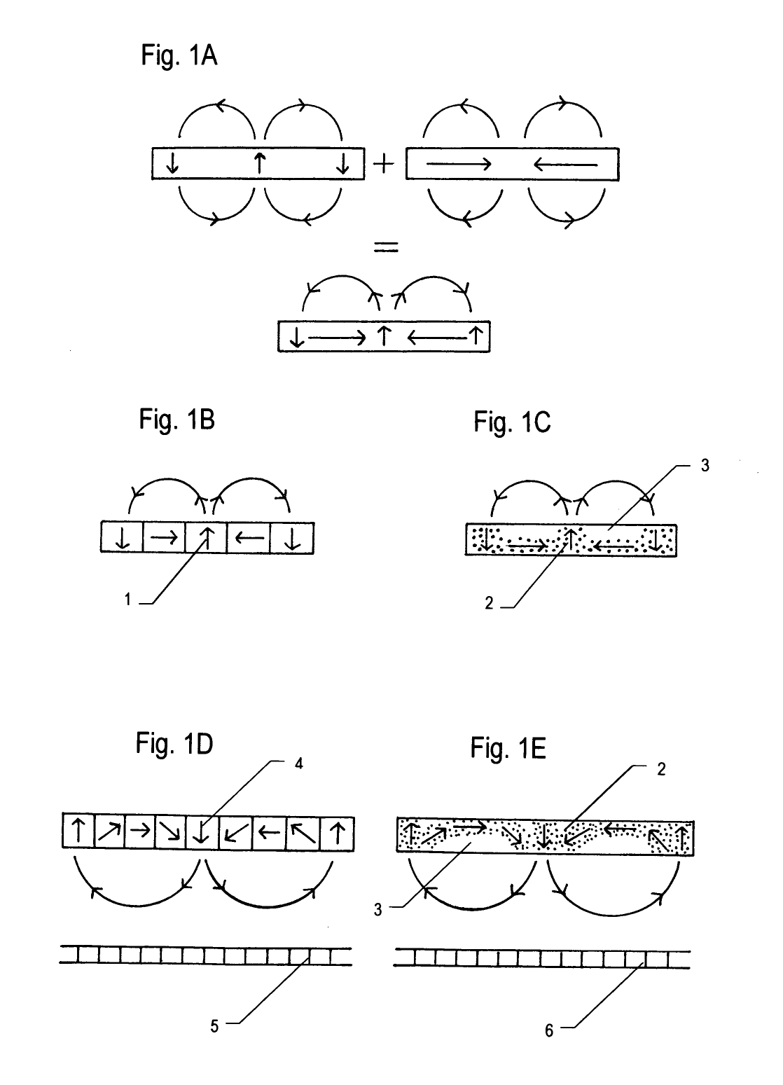

Note, FIGS. 1C, 1E, 2G, and 2H depict magnetic particles integrated into a matrix material to form a component which can be described as an integrated magnetic multi-pole array.

FIG. 3A Shows a prior art permanent magnet rotor motor with magnet segments item 9 which could in the prior art be replaced by a formed to shape homogenous blend of magnetic particles and binder which would have specifically located magnetized poles in place of the magnet segments. Said rotor interacts with magnetic field forces created by the stator 8 which in the prior art could be formed from multiple sheets of soft magnetic laminate material within a machine casing or housing, or alternatively the casing and stator item 8 could be formed from a homogeneous blend of soft magnetic particles and binder material thereby forming both the machine casing and an integral stator.

FIG. 3B Incorporates embodiments of the present invention wherein the casing and stator are an amalgamated integration of soft magnetic particles forming as example salient stator poles and a back flux path while the structural matrix material acts as a binder for the magnetic particles and a structural machine casing component in one item potentially improving structural integrity and also magnetic flux as each specific material concentration is placed where it is required for maximum benefit unlike the prior art homogeneous distribution which tends to be a compromise, neither optimizing structural integrity nor magnetic field producing capacity. The rotor of FIG. 3B shows an array of permanently magnetic particles, item 12 amalgamated into a rotor matrix core of another material type, item 11 which could for example be an aluminum alloy, suitable alternative or alloy there of.

A back iron flux path is no longer necessary as the magnetic particle array also form an efficient back flux return path. Said rotor forms an integrated unitary structural component comprised of non homogeneous specifically located concentrations of magnetic particles incorporated and amalgamated into a structural matrix forming material, which can have vastly greater structural integrity to that of the prior art while also creating a more efficient magnetic field interactive mechanism than that offered by the prior art. This embodiment and principles there of can be utilized in numerous mechanisms, one of which is Hybrid and Electric Vehicle motor/generator systems and accessory drive motors.

FIG. 3C Incorporates soft magnetic particles, item 10 to form “V” cores for the “V” coil arrays all of which are an integrated part of the structural matrix which forms the motor design with permanently magnetic particle arrays shown as item 12, a rotor with spokes which may be fibre reinforced and matrix material which may be any suitable material, as example aluminium or suitable alternatives, wherein the void regions, apart from lightening the structural also assist manufacture and magnetizing of the permanently magnetic particles. Said particles could also be soft magnetic particles which form “unseen” salient rotor “projections” within a non magnetic matrix therein allowing the motor so formed to function as a reluctance type synchronous motor, as apposed to the permanent magnet synchronous motor configuration utilizing the permanently magnetic particle array.

Note that all stator assemblies shown in FIGS. 3A, 3B, 3C have coil wound salient stator cores, for simplicity the coils are not shown however the direction of coil flux applied to adjacent “V” coils is shown on the particle cores of FIG. 3C.

FIG. 4A Shows an axial flux rotor utilizing specifically located concentrations of permanently magnetic particles, forming a one sided reinforcing array of the “Diagonal V” formation of the forth embodiment of the present invention, therein forming what will be described as a Distributed Magnetic Metal Matrix Composite Disk wherein as example said disk matrix is an aluminium alloy or suitable alternative.

FIG. 4B Shows a process for manufacture of the disk wherein former plates 16 and 17 comprising specifically located and pole aligned magnetic field forces create a mold which is filled with a blend of, in this example aluminium particles which may be specially coated to assist the process, and specially multi-coated permanently magnetic particles which are preferably anisotropic particles in this example, optionally specially coated short fibres of for example carbon can be added to improve structural integrity. The total particle mass being subjected to high frequency vibration and if necessary gaseous intrusion to create a fluidized particle bed wherein specific magnetic particles primarily separate from the non magnetic matrix material or differing magnetic matrix material leaving only a small amount of matrix particle within the specific magnetic particle concentration which due to the application of specifically located and aligned magnetic field forces associated with the former plates causes the specific permanently magnetic particles of this example to assume the desired magnetic array formation while also aligning the anisotropic particles in the preferred magnetic pole alignment.

Utilizing Powder Metal and Metal Matrix Manufacturing Technology the Powder Metal Disk is exposed to heat and pressure to form a structurally integrated disk which may be further processed to further densify and finish the component as necessary. If necessary the finished product may be further magnetized.

An alternative to blending a matrix powder with magnetic particles is to form magnetic particle preforms which can be pre-magnetized into the desired arrays the particles of which are bound together by a final particle coating for example which is exposed to moderate heat and molding pressure. These magnetic particle preforms would then be assembled in the mold between the former plates 16 and 17 and held in place by a magnetic field applied by the former plates or alternative adhesion means said preforms being the inverted “V” formations of particles, items 13 and 14 which would form a series of separated slightly porous preforms assembled into the mold between the former plates. The mold would be closed and injected from above and below as example with high pressure molten aluminium alloy, or suitable alternative, which may be a fine metal powder which assumes the flow characteristics of a liquid or molten metal, the temperature of the molten metal or alternative heat and pressure treatment, would decay the preliminary bonding coating applied to the magnetic particles exposing a secondary matrix compatible coating which fuses and partially sinters the particles while also allowing some infiltration of matrix material into voids between magnetic particles. Since this can be a relatively high temperature process it is desirable to apply magnetic field forces to the magnetic particle arrays as the component cools to achieve the desired magnetic flux characteristics of the component. References given within this disclosure explain in depth the metallurgical technology and associated techniques.

Magnetic particles referenced in relation to FIG. 4B could also be soft magnetic particles or specially treated electrically conductive particles wherein said particles are attracted to an applied magnetic field and specifically located particle concentrations form within a matrix of a different material.

FIG. 4C Depicts a mechanism utilizing components manufactured by the prior mentioned process. Matrix material Item 24 can if desired form the primary structure of the disks shown in section in this drawing and the axial support structure or alternatively the disks can be attached to the axial support structure. There is no specific limit to the number of disks that can be mounted coaxially however in this example a pair of disks is shown as example. An appropriate disk shaped drive coil Item 23 is positioned in a gap between the disks. The drive coil may be installed in sections. The reinforcing field faces of the disks shown in this example face toward the drive coils, as would be the case if “Halbach” or other arrays were chosen in preference to the “Diagonal V” array of magnetic particles of this example. Reinforcing arrays Item 22 on the section and also shown in FIG. 4A, as north pole arrays Item 13 and south pole arrays Item 14 should preferably be arranged so that the north pole array on one disk faces the south pole array on the adjacent disk with the drive coils and an air gap separating the disk faces. A small radial misalignment of north-south arrays can create flux lines which are skewed from axial alignment and may benefit motor/generator characteristics in some circumstances.

The disks are supported on an axial support shaft which as example can be aluminium alloy and is itself supported by passive magnetic bearings acting in the repulsion mode. These are shown as having “Diagonal V” arrays; though alternative arrays are equally suited; of permanently magnetic particles integrated into the matrix of axial support shaft Item 30 and as a separate attachment of a Distributed Magnetic Metal Matrix Composite attached to the axial support shaft Item 21. These are conical in shape as are the outer repelling arrays attached to supports Items 20 and 27 or being an integrated part of the supports Items 28 and 29, which may be single or multiple components. In all instances reinforcing arrays face the air gap and like poles are opposite one another across the air gap. Like poles repel and the conical formation acts both axially and perpendicular to the axis thus restraining the shaft in all directions. Further axial restraint can be achieved mechanically Item 31 or by utilizing an addition magnetic flux in repulsion mode Item 19. Item 31 could be replaced with a drive take off for direct mechanical connection.

The passive magnetic bearing mounted disk motor/generator assembly could with the attachment of a wheel rim and tire assembly to the outer circumference of one of the disks provide a self contained magnetic bearing supported wheel drive assembly for a light weight vehicle with the bearings providing frictionless support.

The passive magnetic bearings may be replaced by ball or roller bearings of a conventional form.

Power take off may be from either or both ends items 19 and 31 or the mechanism may function as an energy storage device wherein generator mode returns power to the system.

Such disk motor/generators have a wide array of uses and the reduced complexity, efficiency and structural integrity achieved utilizing embodiments of the present invention further expands the realms of usage.

As regards Hybrid and electric vehicles said disk motor/generator have a multitude of uses. The compact nature of the disk motor/generator lends itself to usage in all form of accessory items from fan motors to water/oil pumps to air conditioning pump drives. A significant amount of primary drive and motor/generator functions can be achieved using such a Distributed Magnetic Metal Matrix disk motor/generator.

As example such a system can be attached to one or both ends of the crankshaft of a hybrid I.C. engine replacing the flywheel and dampener therein acting as an additional power source to the I.C. engine, acting as a generator and also assisting engine braking under deceleration therein regenerating braking energy, and also taking the place of the startor motor. Such disks can be built into transmission casings, added to drive shafts in for example a multiple series of such disks to provide an extremely compact yet powerful motor/generator or, as a following figure shows, mounted within a wheel in the region of the conventional brake disk. The same principles can be applied to drum shaped rotor/stator components.

FIG. 5A Depicts a wound rotor D.C. brushed motor utilizing commutators and brushes or a slip ring, brushes and electronic control unit, to transfer power to the rotor windings. The rotor can as example be a conventional prior art core generally made up of soft magnetic laminate stacks or as a homogeneous soft magnetic particle core.

However in this present invention embodiment example the rotor is formed from non magnetic material for example aluminium, magnesium, titanium or stainless steel with distributed concentrations of integrated soft magnetic particles amalgamated into regions which form salient rotor cores item 32 utilizing embodiments of the present invention. Which are then wound with insulted conductive wire to form drive coils ,or alternatively said drive coils can be housed within the magnetic particles of the rotor core or placed within co-axial cavities formed in the particle core. The inner coil region is then filled with magnetic particle material thereby further strengthening flux.

The casing would in the prior art either support permanent magnet segments or have wound field coils as in FIG. 3A item 8.

However utilizing aspects of the present invention the casing matrix or structural matrix in this example contains specifically located concentrations of permanently magnetic particles item 34 which form poles within the non magnetic motor casing matrix, item 33. The casing structural matrix can be formed from aluminium, magnesium, titanium, stainless steel, or suitable alternative and can also be fibre reinforced utilizing, carbon, boron, glass, or other suitable fibre. The casing can also be of a non-metallic material such as plastic which is formed from a blend of magnetic particles, plastic particles and optional reinforcing fibre wherein said casing is a structural integrated component providing magnetic field producing capabilities while also performing the role of a machine casing. An example of the machine type would be an electric drill, an angle grinder, an electric tooth brush, a house hold electric machine, a fan, and numerous other mechanisms. Most of the accessory drive motors used on Hybrid and electric vehicles can utilize this type of motor as it is low cost, small, robust and easily mass produced. The casing can be as example, metal, composite, plastic, reinforced plastic or any suitable alternative.

FIG. 5B Depicts a permanent magnet rotor and utilizes a machine casing similar to that explained in relation to FIG. 3C and requires no further explanation as said machine casing utilizes several embodiments of the present invention, however the rotor differs significantly from that of FIG. 3C although it also utilizes distributed concentrations of specifically located and pole aligned permanently magnetic particles these particles are now concentrated in salient rotor poles item 35 while the rotor matrix or structural matrix is primarily a non magnetic material such as aluminium or suitable alternative as was the case with the rotor of FIG. 3C although both rotors could also be formed of a suitable plastic material. The salient rotor poles of FIG. 5B utilize aspects of the first and second embodiments of the present invention the principles of which were described in relation to FIGS. 2G and 2H wherein a permanent magnetic particle array distributed within a different material matrix in specifically located concentrations forming magnetic arrays with specific pole alignment and had a co-axially imposed electro-magnetic field imposed upon the permanently magnetic field to reinforce said permanently magnetic field and thus improve motor torque characteristics while also reducing the chance of demagnetization of the permanently magnetic material and additionally allowing field weakening of the rotor flux at higher speeds thus further improving motor efficiency and speed capabilities.

A motor/generator of the type shown in FIG. 5B could also function as a reluctance type motor with salient rotor cores utilizing soft magnetic particles in place of the permanently magnetic particles and without the coaxial rotor windings or remotely applied coaxial flux to the rotor. Maintaining a certain amount of permanently magnetic particle material specifically located along with salient soft magnetic particle material can create a motor which has both magnetic and reluctance drive characteristics.

It should be noted that the motor/generators depicted are representative of the principles associated with the present invention and numerous motor types and designs can utilize principles of embodiments associated with the present invention.

FIG. 6A Shows several methods of incorporating a Distributed Magnetic Metal Matrix Composite material into, as example an in wheel drive system for a Hybrid and or electric vehicle and extends the principles of a prior U.S. Patent by the inventor of this present invention. The disk drive and regenerative braking system items 22,23,24 show at least two disks designed in a similar fashion to those shown in FIG. 4. The mode of operation will be evident upon referral to the description of FIG. 4. It should also be noted that depending on the motor drive type, permanently magnetic synchronous AC/DC as the example or reluctance type or induction type, said magnetic particles may also utilize soft magnetic or electrically conductive particles specifically distributed in non homogeneous amalgamations.

From an operational point of view such a disk system would replace the original friction disk brake.

The trend toward larger diameter wheels and lower profile tires allow quite a large diameter drive surface as represented by particle concentrations 22 and 24 and flat disk shaped drive coil item 23 which can result in quite high torque and good regenerative braking characteristics. Also since the disks would be made of as example, aluminium, ceramic composite, carbon composite or suitable alternative and the total system including the friction disk brake and caliper items 39 and 38 respectively; which act at a large radius and are smaller than original due to the braking assistance provided by the regenerative braking system which also acts as a motor drive and generator as required; probably weighs a similar amount and possibly less than the larger diameter cast iron original brake disc and associated caliper found on many high performance vehicles. The disk item 39 can be an extension of the main drive disk and be suitably surface treated in the region of friction contact with the brake pad or can be a separate floating disk utilizing the inner main drive disk as a hub for attachment utilizing easily available fasteners in location 40.

FIG. 6A also shows an embodiment utilizing permanently magnetic particles item 2; which in an alternative motor type could be either soft magnetic particles or electrically conductive particles; specifically located within the matrix or in this example the structural matrix item 3 of an inner wheel rim item 36. The magnetic particles are laid out as per FIG. 4B items 13 and 14 however in this instance the X-X Section would be taken through the centre of the magnetic array around the circumference of the inner wheel rim. The drive coil 23 in this instance would be of a cylindrical shape maintained at a constant “air gap” distance from the inner rim. Suitable structural resins being available for binding and protecting the drive coils. The wheel rim can be formed from any suitable material as example, aluminium alloy, magnesium alloy, titanium, carbon composite or a standard non magnetic rim to which an inner distributed magnetic particle array in the form of a hoop is attached.

It should be noted that although this embodiment utilizes “Diagonal V” permanent magnet arrays as example any suitable array such as “Halbach” or alternatives can be used utilizing the principles of embodiments of the present invention.

The described disk drive, regenerative brake, and friction brake combination can be easily installed in new Hybrid and electric vehicle as can the wheel rim drive/generator and regenerative braking system.

The systems as shown because of the nature of incorporation of most of the drive system within a pre-existing or in place of a pre-existing component add minimal weight. Also when utilized on large diameter wheel rims these systems when applied to potentially all four wheels are capable of generating significant torque and regenerative braking capabilities.

Such systems are very easily retrofitted to existing vehicles, and can be especially useful to a company wishing to down size the motor in a particular model range to achieve the necessary economy/pollution criteria while maintaining suitable performance and drivability characteristics without the necessity to redesign the basic vehicle or drive train structure, as with the exception of suitable mounting structure for the drive coils, these systems are purely a “bolt on” option, and the electronics to allow integration into a vehicle are easily available in the market place. Additionally these systems apply their torque directly to the road and do not create any greater stress on the suspension system than those applied by the original braking system thus requiring no major mechanical redesign of the vehicle to which they are fitted.

FIG. 6B Details a frictionless servo-assistance steering rack mechanism which overcomes the “friction” or “stiction” effect often associated with electric steering servo-systems which rely on a directly gear connected electric motor for their servo-assistance. The electric motor is often directly geared to the steering column, is generally electronically and or micro-processor controlled and often mimics road feel by “feed back” weighting while not giving the driver any true idea of the actual tire to road slip condition. This is acceptable to a large number of drivers and unacceptable to a significant number of drivers many of whom consider driving a pleasurable activity rather than a means of purely getting from one place to another.

Since electric servo-assisted steering can be expected to dominate the Hybrid and electric vehicle sector the present invention and the embodiment of magnetic particles in specifically located concentrations within another material matrix or structural matrix allows the creation of a novel, non contact steering rack servo-system. FIG. 6B shows a steering rack item 41, its casing item 42 and the rack pinion gear item 43.

The rack can be manufactured from a non-magnetic material for example stainless steel. The rack and its incorporation of specifically located distributions of, for example permanently magnetic particles, can be manufactured to precise tolerances by powder metallurgical techniques or other suitable techniques. The magnet arrays can for example be those of the “Diagonal V” array as shown and described for a disk item in FIG. 4B and in particular the passive bearings of FIG. 4C. However the form of the array will follow that of the X-X section of FIG. 4B axially along the rack with rings of like poles running around the circumference of the steering rack rod section item 45 as was the case with the passive magnetic bearings item 30. Thus forming separated magnetic North-gap-South rings of magnetic particles integrated into the structural matrix of the steering rack. Drive coils 44 are built into the circumference of the rack casing, creating a vehicle which employs a maximum efficiency magnetically interactive mechanism thus the rack and casing provide the servo-action avoiding usage of a second motor servo.

The use of such a system is considered unique and novel however for this specific usage the use of rings of permanently magnetic material forms a new use for a prior art tubular linear motor/actuator which confines rings of rare earth magnetic material within a sheathed thrust rod. These linear servo-motors utilize electronically controlled magnetic drive coils around the circumference of a non magnetic thrust rod with alternating North-South rings of rare earth magnet segments along the working length of the thrust rod. These are known as “tubular” or “encased” linear actuators and the incorporation of such a servo-motor into a vehicle steering rack assembly represents a new use for such a system in the case of utilizing conventional magnet ring segments.

However the use of the first embodiment of the present invention to replace the magnet segments with a Distributed Magnetic Metal Matrix composite system further adds to the Novelty.

The use of embodiments of the present invention in such linear actuators and liner servo-motors should also be considered novel as the replacement of magnet rings which then require sheathing in a stainless steel “jacket” is time consuming and costly. The present invention can allow easier production of said thrust rods associated with linear actuators/motors, while also allowing placement of magnetic particles and matrix material to avoid the use of sheaths or jacketing since a thin layer of matrix material can be retained outside the magnetic particle arrays, all being within an integrated component. Additionally the structural portion of the rod is increased resulting in a significantly stronger rod section, which in the prior art is turned down to a smaller diameter to accept the coaxial magnet rings.

### Preferred Embodiments

The primary objective of the present invention is to create a vastly more efficient, structurally integrated electro- magnetic field and magnetic field interactive machine or mechanism, wherein interactive relates to the mode of operation of the mechanism as a result of at least one magnetic field producing component having an effect on another element or component in a predetermined manner. Said effect could for example be the induction of an electric current or an opposing magnetic field or a transfer of torque or energy from one component to another, via magnetic or electro-magnet field interaction.

Machine or mechanism types which can primarily benefit from the present invention are those which involve the usage of permanently magnetic material, and electro-magnetic and magnetic mechanisms. Hybrid and Electric Vehicles and the overall efficiency and integrity of the vehicle is dependant upon all such mechanisms working to utmost efficiency in terms of energy usage, long term reliability, structural integrity, weight and size management, cost and ease of manufacture. Most hybrid vehicles and a major proportion of all electric vehicle primary drive systems and secondary “accessory” motor drives utilize Permanent Magnet Motors and virtually all of these use attached or embedded permanent magnet segments or formed to shape magnets wherein these magnets are generally a relatively homogeneous blend of magnetic particles or particles with an amount of binder material distributed around the particles forming a homogeneous blend.

The present invention differs totally from the prior art by taking a component and incorporating into the matrix or structural matrix of the component specifically located concentrations of magnetic field producing elements in predetermined distributions.

This present invention allows the creation of a new generation of magnetic and electro-magnetic field interactive machines which are smaller, lighter, more robust, potentially more energy efficient with a higher power to weight/size ratio. Characteristics that are critical to the efficiency and development of Hybrid and Electric Vehicles and most other similarly interactively motivated mechanisms and machines.

These new and novel interactive elements allow the creation of new and unique machines and drive mechanisms a number of which relate to vehicles.

Inspection of the provisional specification which is claimed as a priority document to be read in association with the present invention describes and portrays a number of drive mechanisms for vehicles or machines.

A number of drive mechanisms are shown ranging from multiple discs, flywheels and similar structures attached to drivelines, transmission housings or wheel assemblies, wheel rims and hubs all of which can incorporate magnetic field producing elements, as can secondary rings or disks attached to the primary items and manufactured utilizing principles of the present invention. Although these are secondary attached components, they are also composite structural items with specifically located concentrations of magnetic field creating elements integrated into a matrix which differs totally from attached magnets or formed to shape ring magnets of the prior art.

A number of potential drive mechanisms follows as example and should not be construed as being complete as those skilled in the art will understand that the principles of the present invention can be applied to a large proportion of magnetic field and electro-magnetic field interactive mechanisms/machines.

Mechanisms and drive modes explained in the provisional specification which is included in totality as a priority document are listed below without elaborate explanation as the principles involved will be understood by those skilled in the art. Incorporation of magnetic particles into appropriate static or rotational components of a drive system and incorporation of said magnetic particles into metallic components such as Aluminium, magnesium, titanium or non metallic components such as carbon composite or ceramic, said components being, stator or rotor discs, hubs, wheel rims, housings, wherein generally the magnetic particles are incorporated or amalgamated into the matrix, however since incorporating magnetic field producing medium into the matrix of many of the described components is novel the usage of embedded magnetic segments, coils, conductive material or magnetically soft material, will also be novel as will be the case with specifically located concentrations of magnetic particles amalgamated within the component matrix of rotor disks and stacks of rotor discs and static components interleaved within said rotor disks, flywheels and or drive components. Magnet arrays may be a Halbach or alternative array, formed by magnetic particles in the component matrix or surface matrix or alternatively entrapped permanent magnet material in specific arrays may be utilized.

Component material can be ceramic composite, carbon composite, carbon ceramic, metal matrix composite, metal matrix, steel, stainless steel, cast iron, aluminium, magnesium, resin composite, or any suitable material in association with suitable magnetic material.

Magnetic particles varying in size from nano-particles to large particles several millimeters or more in size can be utilized to achieve a composite matrix or alternatively a composite surface matrix wherein magnetic particles are oriented and or concentrated in predetermined locations and field orientations and alignment.

Magnetic Particles can be distributed throughout the matrix in mechanisms or machine components wherein this would represent a new and novel solution, or concentrated and or aligned in specific location with specifically aligned poles in relation to the “gap” surface as a result of the manufacturing process and also as a result of imposed magnetic fields during manufacture, especially relevant to anisotropic permanently magnetic particles.

It will be realized by those skilled in the art that procedures and technological developments referenced in the prior art patent documents listed can easily be utilized to produce embodiments of the present invention. For example magnetic particles can be incorporated into Powder Metallurgical Components and those of metal matrix composites and non metallic matrix type composites, the magnetic particles being surface treated or coated for compatibility with the matrix material of the component. Magnetic particle concentration location, and alignment being the result of formed preforms or particles held in position by magnetic field forces as example.

There are numerous means and methods of achieving the desired component form and only a few examples are given to facilitate understanding of the principles by those skilled in the art.

There are also numerous electric motor drive systems, motor/generator types, electronic control units, microprocessors and an array of equipment easily available in the market to those skilled in the art which can provide the requirements of the present invention and only a few examples are listed to facilitate understanding of the principles associated with the present invention.

Application of magnetic fields during component manufacture can align and magnetize permanently magnetic particles to achieve better concentration of particles and localized magnetic field forces while aligning anisotropic particles in optimum direction. Magnetic particles, soft magnetic particles and electro statically charged particles including piezoelectric particles, as example can be similarly distributed and concentrated throughout a matrix of differing particles or particles of differing magnetic field. The process of localization, concentration and alignment of particles can be further assisted by creating a fluidized bed of particles resulting as example from vibration, being mechanical, acoustic, or electromagnetic variations.

Following manufacture final magnetizing of the magnet particles in their predetermined patterns and field alignments can be carried out resulting in components with concentrations of North/South magnetic poles distributed in specific locations of the component face, said component can be for example a friction rotor of a disk brake, an attachment to said brake disk, part of a wheel hub, wheel rim or attachment to said wheel rim, a flywheel, disk or drum type attachment to a rotational component of a motor drive component, drive shaft, gear box or transmission component or numerous other components creating a new and novel drive system.

In addition to providing magnetic field effects the magnetic particles can reinforce the structural matrix of the component in much the same way as aggregate and sand reinforce a cement matrix to form concrete, specific sizing and variation of particle size as well as particle concentration in specific regions of a component can provide structural integrity characteristics suited to specific regions of a component while also providing regions of highly concentrated magnetic flux.

Rigidity and a high modulus of elasticity in compression is associated with a high concentration of magnetic particles in a “binder” matrix while a region of diminished magnetic particle concentration takes on the characteristics of the matrix material which may be a ductile, high tensile, low or high modulus material allowing a composite material with highly beneficial variable structural characteristics which can be “tailored” to suit the region of usage.

Since magnetic particles can be of much higher hardness than the component matrix these particles can greatly improve wear resistance and increase the coefficient of friction of a surface.

Clusters of particles can be incorporated into the matrix and surface matrix of both metallic and primarily non-metallic components, for example, disks during the manufacture of the disk by using a pair of “former disks” which provide a “mold” for the new disk. These “former disks” can have specifically located and aligned magnetic fields across their surfaces in predetermined patterns forming specific arrays, clusters of anisotropic or isotropic permanently magnetic particles are attracted to the fields and aligned (anisotropic). Infilling void regions within particle concentrations and the general matrix using, resins, or molten metal can utilize procedures well known in the art and referenced in this disclosure can result in a formed disk with arrays of specifically located concentrations of magnetic particles impregnated and amalgamated within the disk matrix, whether that be aluminium alloy, or other metals which penetrate the voids around particles during disk formation or impregnates the boundaries of the particle clusters while heat and or pressure fuses or sinters the particles. Said particles may be pre-coated with a material similar to or compatible with the matrix material, thereby creating an integrated structure of high structural integrity.

U.S. Pat. No. 5,594,186 Krause et al. filed Jul. 12, 1995 and U.S. Pat. No. 6,502,423 Schmitt filed Aug. 30, 2000 Describe technology utilized in the field of Metal Matrix Composites aspects of which can be utilized in the manufacture of the present invention.

A metal matrix composite, carbon ceramic or carbon composite or resin composite matrix material amalgamated with magnetic particle clusters in specific locations and concentrations can form for instance a wheel rim with a high proportion of magnetic particles in appropriate regions while maintaining impact resistance and structural integrity in regions designed for primary strength has great advantages over a uniform blend of particles throughout said wheel rim which creates a brittle inefficient structure with inefficient material usage as would be the case with a uniform highly concentrated “costly” blend of magnetic particles throughout the component as used in prior art. Metal Particles or molten metal are easily formed into complex shapes and as with the prior mentioned matrix materials can impregnate a magnetic particle array. Said magnetic particles could also be specifically shaped and aligned preforms of bonded or sintered particles held into specific locations within a mold by for example, magnetic fields associated with the mold which would have a secondary benefit of pre-aligning anistropic particles during the manufacturing process resulting in stronger more concentrated fields. As example U.S. Patent Application 20090311541 Anderson et. al. which could be utilized for forming some components associated with the preset invention.

Magnetic particles 5 to 10 microns or larger particles or as small as nano particles are presently commercially available in the field of magnet manufacture. The particles may be coated or etched to assist bond, mixing, and amalgamating with the matrix material.

Carbon/Resin composite automotive and bicycle wheel rims are presently marketed and these same materials can easily be manufactured using similar techniques to those presently involved but including specifically located concentrations of magnetic particles thereby creating wheel rims with magnetic field creating capacity. However specifically located and distributed concentrations of magnetic particles integrated and amalgamated into a metal matrix or structural matrix to form a Distributed Magnetic Metal Matrix Composite is even greater significance to the principles of the present invention.

Such a wheel rim can be formed in a mould or former, Vacuum forming is often employed with resin/plastic matrix binder materials. The mould would generally be fitted with specific magnetic field arrays which “mirror” those arrays required in the finished magnetic rim section. Resin/Plastic components are generally heat cured in an autoclave after which permanently magnetic particles; anisotropic or isotropic, though anisotropic will yield a higher flux density, will be finally magnetized if the in mould magnetizing is insufficient. A wide array of components can be similarly formed, these can for example be wheel hubs to which a brake disc is attached, various discs, such as flywheels and rotational components attached to a vehicle drive line, which when associated with electro-magnetic drive coils can provide motor/generator capabilities, U.S. Pat. No. 4,995,675 Tsai filed Jul. 12, 1989 describes, a method of manufacturing carbon composite wheel for a bicycle. Combining these rims with an adjacent electro-magnetic coil array can create a wheel structure capable of drive and regenerative braking using prior art motor/generator theory and electronics, which differs totally from prior art wheel drive systems which attach magnetic field creating elements to a wheel structure, often in the form of magnet segments, and is unlike the present invention which integrate arrays of magnetic particles within the matrix or structural matrix of in this example, a wheel rim, with due consideration to both magnetic field creation and maintenance of structural integrity in a simple amalgamated component. A distributed magnetic metal matrix composite component can be formed by combining Particle Metallurgical Technology, Metal Matrix Technology and Metal Matrix Permanent Magnet Technology, examples of which are referenced.

Using Metal Matrix Composite experience, powder metallurgical techniques, squeeze casting, rotary forging, Metal Injection Molding, and a variety of methods associated with manufacturing metal bonded magnets, suitable methods of manufacture are available which can integrate a wide array of metallic materials and magnetic particle distributions to form a structurally sound component.

Since most permanent magnetic particles and the majority of soft magnetic particles proposed for usage are attracted to magnetic fields the use of such fields in moulds and formers is a good solution for placement of particles and arrangement of particle arrays and holding the particles or preforms of said particles in position while infilling the mould with powdered metal alloys, plastic or molten metal phases. WIPO Patent WO/2004/062838 Powder Metallurgical Production of a component having Porous and Non Porous Parts, describes a procedure for producing a component with specific regions of different material such methods can be utilized by the present invention to form a component containing specific concentrations of magnetic particles.

As example, a metal alloy for instance aluminium alloy, wheel rim can be formed from aluminium in the plastic or semi-molten state. Magnetic particles or preforms of magnetic particles can be held firmly in a mold by strong magnetic fields. U.S. Pat. No. 5,894,644 Mravic filed Apr. 20, 1999 describes a method of infiltrating a porous preform with liquid metal in the case of the present invention the preform can be of magnetic particles, the liquid metal, any suitable metal which can also form regions of component outside the preform region, forming a cast or formed wheel rim. Magnetic fields can align anistropic particles and also magnetize the arrays, which can for example be restricted to the portion of the rim which may for example be maintained relatively flat in section and thus easily associated with an electro-magnetic drive coil array. An alternative method of fabrication would be to use powder metallurgical techniques to form an initially flat strip of aluminium with integrated magnetic particles integrated within the central region of the strip of aluminium thus making forming and magnetizing relatively straight forward, while the outer edges of the strip of aluminium are free of magnetic particles and remain ductile and suited to normal rolling and forming processes.

The usage of the phrase “as example” or “for example” as utilized in the present disclosure is intended to describe one of potentially many options and in no way should “an example” be considered as a sole or exclusive reference thereby binding the limits of the disclosure since those skilled in the art will realize there are numerous alternatives.

A more complex rim shape could be an inner section of a bolted three piece wheel rim which can then be rolled into a ring shape; butt welded and have the ductile edges which do not contain magnetic particles rolled using standard forming procedures for such items to form the desired rim shape while containing within the central region of the rim section a magnetic particle array integrated into the structural matrix of the component. A far lighter, more robust “magnetic field producing” wheel section than that of the prior art which attaches or embeds magnetic segments onto or into a rim section.

A wide array of mechanisms and machine components can be like-wise manufactured utilizing magnetic particle systems of the present invention and prior art metallurgy or fabrication technology combining the mechanisms so produced with permanent magnetic arrays of the forth embodiment, and coil arrays of the second and third embodiments of the present invention to create highly efficient machines or mechanisms. A number of patent are referenced which precisely explain detailed methods associated with the manufacture of components, procedures and methods which can be related to manufacture of the present invention.

Use with Hybrid vehicles is an important aspect, of the present invention. Electric motors, wheels, flywheels, disc and drum shaped components associated with drive components can all utilize embodiments of the present invention. However both internal combustion engines and electric motors can benefit from some form of gear reduction system to transfer torque.

The present invention is ideally suited to the manufacture of magnetic drive and torque transfer systems. “Magnomatics” systems were previously referenced. These systems evolve very little heat, as there is no direct contact involved and minimal losses thus such magnetic gear boxes and power transfer systems do not necessarily have to be built of metal, composites and reinforced plastics can also be utilized in the manufacture, thus integrating specifically located concentrations of magnetic particles, as described in embodiments of the present invention, into components of these mechanisms can create small, light weight, efficient, easily mass produced “magnetic gearboxes” which are ideally suited to Hybrid and electric vehicles and numerous other power and torque transfer mechanisms.

As another example of the wide array of uses for the present invention, consider electric hand tools, drills, angle grinders, saws and numerous house-hold appliances.

Most of these machines have a significant portion of the casing formed in plastic. Within this casing is generally housed a stator of steel laminates or soft magnetic core material and field windings. Some of the latest electronically controlled machines utilize permanent magnet segments attached to the rotor while most utilize commutators and brushes powering a coil wound rotor. The segmented commutators and associated brush sparking causes brush and commutator wear.

The stator core and field windings take up a lot of space, add weight, and are a significant source of overall machine efficiency losses.

Some of the most recent machine developments aim to replace the coil wound/commutator rotor with either attached magnet segments or a formed to shape magnetic material can be suitably replaced with embodiments of the present invention there are several other alternatives which can result in a smaller, lighter, more efficient yet equivalently powerful machine. An example is to incorporate within the casing of the machine, which in this example is plastic, arrays of permanently magnetic particles amalgamated into the plastic casing in specifically located and flux aligned concentrations to form suitable magnetic arrays which do not require “back iron” as a flux “return” path and concentrate most flux on the rotor gap face. One such array would be the so named “Diagonal” or “V” array of the forth embodiment of the present invention. This magnetic stator would react with a wound rotor similar to the original rotor which can use the original commutator rotor or slip rings in place of commutators and electronic control of power supply as the more suitable solution as brush wear and sparking would be greatly reduced. The original commutator system is also usable though this may also require electronic control of power supply. The machine effectively functioning as a synchronous AC or DC machine depending on overall design and electronic control chosen.

The advantages of the first and primary embodiment of the present invention are clear from this example.

A large, cumbersome, inefficient, somewhat difficult to manufacture coil wound stator is replaced by a much smaller, lighter, more efficient, robust and virtually fail safe array of permanently magnetic particles amalgamated, and integrated into the structural matrix of the machine casing in specific, precisely controlled locations and concentrations creating a machine that is potentially significantly smaller and lighter than electronically controlled machines using permanent magnet rotors and large cumbersome coil wound stator cores.

A potential improvement of the above noted cumbersome coil wound stator core of the prior art would be to utilize the first and third embodiments of the present invention to amalgamate magnetic particles into the machine casing however in this case the magnetic particles would be soft magnetic particles forming cores amalgamated into the casing and being coil wound. Said cores could be set out in a “V” coil array thereby avoiding long “return” flux paths which are normally created in the “back iron” of the stator. Such a design would allow a smaller lighter machine than that of the prior art, and can utilize an array of rotor type. The housing or case of the machine would be primarily matrix material of the desired structural integrity blending and integrating into the “V” coil cores which are primarily magnetic particles with surface treatment to allow compatibility with the structural matrix of the machine casing.

Thus several different machine designs are described one using a brushed rotor and permanently magnetic particles integrated into the machine case and others using a permanently magnetic rotor (PM), a reluctance type rotor, an induction type rotor or a combined reluctance/PM rotor, formed according to embodiments of the present invention and a coil wound stator utilizing the machine casing into which stator core material is integrated again utilizing embodiments of the present invention and offering significant advantages over the prior art.

The above examples highlight typical modes of usage of embodiments of the present invention which can be applied to the vast majority of machines and mechanisms which operate as a result of magnetic field and or electro-magnetic field interaction.

Another example of a magnetic/electro-magnetic field interactive mechanism which can utilize embodiments of the present invention is a pseudo-magnetic-gear-motor/generator of a type similar to that of “Magnomatics” incorporating embodiments of the present invention can create a Hybrid and or electric power, drive and transmission system in one integrated unit which is both highly efficient and unlike the prior art which predominantly utilizes magnetic segments, the present invention utilizing specifically located and distributed concentrations of magnetic particles lends itself to mass production and thus cost savings which is very difficult utilizing the prior art, while creating a more robust, structurally integrated machine than can be created utilizing magnetic segments of the prior art.

Several Engineering companies have announced a range extender purpose built I.C. engine directly connected to a generator to maintain a power charge in an electrically motivated vehicles battery thereby potentially reducing battery weight and size and improving convenience. The I.C. engine/generator, used to charge batteries and or to potentially directly power electric motors the I.C. engine optimized to operate efficiently in a range suited to the electric generator and potentially not optimized to additionally drive the vehicle wheels through a conventional transmission system.

The generator can utilize aspects of embodiments of the present invention to further improve efficiency while reducing size and weight however a key issue mentioned earlier in this present disclosure is to maximize both efficiency and utilization of all power sources to motivate a vehicle, therein maximizing performance of the vehicle in relation to total energy/drive producing items onboard said vehicle. Clearly using every available drive source to power/drive the vehicle during relatively short bursts of acceleration will maximize vehicle performance assuming that achieving this goal does not incure large weight/size/cost penalties due to for example cumbersome gear drives or up grading motors to both charge batteries via, alternators/generators and also drive wheels via a conventional transmission. Clearly there are conflicting issues involved and thus compromises must be made.

Minimizing the compromises especially in relation to drive/power/torque transfer systems is now possible as a result of a prior mentioned magnetic gear/torque transfer/motor/generator combined system known as Pseudo-Direct Drive Electric Machines as previously referenced, and also referenced along with other types of electric motor/generator systems which can benefit from embodiments of the present invention Refer to “The University of Sheffield Electrical Machines and Drives Research Group”.

A “magnetic gearbox” is much less restrictive in terms of engine drive, the magnetic gearbox possessing almost infinite drive variability thereby allowing said I.C. engine to operate in its optimum while the magnetic gearbox transfers torque to the wheels. For example a purpose built I.C. engine placed transversely in a vehicle chassis, as is common front wheel drive practise with a pair of pseudo direct drive motor/generator/magnetic “gear box” attached directly to each end of the I.C. motor crank shaft can drive a pair of wheels via the magnetic gear box systems, which generally would be micro-processor controlled/monitored, thereby doing away with conventional gearboxes and differentials. During maximum performance the I.C. motor would drive the wheels via the magnetic gear boxes, additionally the motor/generator section of the “pseudo-direct drive system” would also power the wheels utilizing stored battery/capacitor energy, thus maximizing usage of all drive systems available.

The “pseudo direct drive” can be electronically controlled and micro-processor monitored to totally or partially “switch out” the I.C. engine effectively “declutching” the engine during regenerative braking or during electrical drive of the wheels, the wheels can be fully driven by the I.C. motor, while the generator, section of the “pseudo direct drive” utilizes part of the I.C. engine energy to also charge the batteries, at standstill the I.C. engine can provide charge energy only thus an almost infinite array of drive/recharge/regenerative energy usage is possible by electronic control of such a system, this would also easily incorporate A.B.S. antilock braking, anti-slip, stability control and all other manner of electronically controlled safety aspects of the vehicle dynamics.

Clearly the highest efficiency, maximum performance vehicle will utilize as many drive mechanisms carried by the vehicle for more than just one purpose with minimum compromise. As exampled the “pseudo direct drive system” allows a purpose built I.C. engine to function efficiently as both a highly efficient drive for an alternator/generator and also to “assist” in driving the vehicle wheels directly when higher performance is desired. This system is highly efficient when used with Hybrid and electric vehicles and especially suited to using embodiments of the present invention.

Utilizing as many drive items as possible can at minimal cost allow maximizing vehicle capabilities for instance air conditioning pumps are found on most automobiles produced, and are generally directly belt driven from an I.C. engine via an electrically actuated “clutch” mechanism. Cooling a vehicle interior consumes a large amount of energy, electric vehicles often utilize a combined electric motor to drive the air-conditioner pump while hybrid electric vehicles can utilize either an electric motor drive or direct drive from the I.C. engine. Assume for example that a combined air conditioner pump electric motor/generator is also directly driven by the I.C. engine via the normal clutch/belt system. It is very easy to adapt a system, for example utilizing one or more unidirectional “clutch” mechanisms whereby under maximum performance requirements the air conditioner pump draws no power and the electric motor which normally powers the pump transfers power directly to the I.C. engine to boost performance additionally electronic control allows optimization of efficiency whereby under other circumstance the I.C. engine of the hybrid drives the air conditioner pump plus the motor/generator to recharge batteries and or capacitors, thereby boosting charge and drive capability of the vehicle beyond that of using only the primary electric motor/generator of the hybrid vehicle. The compromise in this example is the maintaining of a clutch and belt drive connection to the motor however the power to drive an air conditioner pump is significant, around 4 kW (5 horse power) is drawn thus a significant amount of power which can assist during “performce” requirements. Reduction in mass and reduced package size allows increased vehicle integration flexibility thus full and total usage of all primary power usage mechanisms will result in a more efficient vehicle wherein motor/generators utilize embodiments of the present invention integration of the “pseudo direct drive system” in place of a conventional transmission system also reduces the compromises.

However a further improvement can be made in the basic design by exchanging aspects of the “prior art” for example attached or embedded permanent magnet segments for an integrated system offered by embodiments of the present invention which can further improve efficiency, reduce size and weight, greatly improve structural integrity and robustness while also greatly easing production difficulties and allowing ease of mass production and inherent cost reductions.

The following patent references disclose aspects of the prior art which can be utilized in the manufacture of components incorporating embodiments of the present inventions.

U.S. Pat. No. 5,123,373 Iyer et.al filed Nov. 5, 1992 Discloses a method for coating fibres used in composites by fluidizing particles with high frequency vibrations allowing even particle coating of said fibres.

As example external forces can be provided by, vibration forces, a magnetic forces an acoustic force a rotational force or combination there-of. Magnetic separators use permanent magnets or electro-magnets and can benefit from a high vibration “fluidized bed” to assist particle separation, fluidization of particles can be assisted by gas distribution within the particle container. Selective heating of specific particles is possible by use of microwave/millimeter wave technology, whereby, for example, magnetic particles can be specifically heated to melt a pre-coating which creates bond of particles within a specific magnetic field/pole/array as determined by an applied external magnetic field array associated with the molding container. WIPO Patent WO/2003/072835 Method and Apparatus for separating Metal Values discloses technology which may be applied to the present invention.

Thus by adopting technology of the prior art and the knowhow of those skilled in specific aspects of the art all elements of the present invention can be realized.

Utilizing methods of the prior art a component or mechanism, for example a rotor disk of a motor, a flywheel disk, a brake rotor disk, a cylinder such as a wheel rim or surround of a transmission component can be formed of matrix material in particle form or liquid/semi liquid or gel form blended with magnetic particles which are confined within a suitable mould or forms. Said former having suitably placed magnetic field arrays or electro-magnetic field arrays which differentially attract the magnetic particles. Application of a fluidizing force such as high frequency vibration which can be externally applied to the former mold or associated with the mold by rapid variation of the magnetic fields applied to the former and or the addition of a gaseous medium can result in fluidization of the mass within the former moulds and separation and attraction of specific magnetic particles in arrays which align pole wise, and cling together to correspond with the chosen array applied to the former molds. Premolds of magnetic particles can be held in place by magnetic field force, adhesive or suitable alternatives. The magnetic particles can be pre-coated with several coating layers, the first of which can bond the particles under the influence of microwave/millimeter wave application to allow easy handling of the preformed component after which final heating, sintering and or pressure application can break down the bond coating, exposing the matrix compatible particle coating which allows “fusing” the component which is a non-homogeneous amalgamation of specifically located concentrations of magnetic particles integrated into a matrix material to form a homogenous structural mass with specifically located, oriented and concentrated magnetic particle arrays. Said component may undergo further densification by gaseous or liquid impregnation techniques or further forming procedures.

U.S. Patents further referenced which provide disclosures of the prior art which can be utilized in some part to realize embodiments of the present invention are supplied as example.

U.S. Patent Application 20090026026 Martino. Vehicular Brake Rotor formed by powder metallurgy. The technology disclosed can be utilized to incorporate magnetic particles into an array of components.

U.S. Pat. No. 4,838,936 Akechi et al. filed May 23, 1988 Forged Aluminium Alloy Spiral parts and Fabrication There-of, discloses high strength high precision components formed by forging aluminum alloy powder.

U.S. Pat. No. 4,915,605 Chan et al. filed May 11, 1989 Method of Consolidation of powder aluminium and aluminium alloys and aluminium metal matrix composites, discloses a powder preform component consolidated under heat and pressure by a bed of flowable particles which transmit pressure and heat.

U.S. Pat. No. 7,553,561 Sakamoto et al. filed Jul. 19, 2005 Rare Earth Magnet, discloses a permanent magnet formed from multicoated magnetic particles to achieve excellent corrosion resistance.

U.S. Patent Application 20080304974 Marshall et al. First Stage Dual-Alloy Turbine Wheel, discloses a first alloy powdered metal “Astroloy” disk to which is joined a second alloy by hot isostatic pressing.

U.S. Pat. No. 4,581,300 Hoppin et al. Sep. 21, 1982 Dual Alloy Turbine Wheel, discloses a dual alloy turbine wheel wherein a direct metallurgical bond is created between the differing alloy component parts. This disclosure could be utilized to metallurgically integrate a component part with another component part which in the case of the present invention could be a part incorporating an array of magnetic particles in specifically located concentrations within said part.

WIPO Patent WO/2004/062838 Powder Metallurgical Production of a Component Having Porous and Non Porous Parts, discloses a component produced by powder metallurgy, methods of achieving metallurgical bonds, between differing materials by pre-coating a metal powder with a coating compatible or of similar composition to the material to which a bond is to be made during sintering.

The structurally integrated component contains a porous region which in the case of the present invention can be magnetic particles which is of varying concentration and varies in density and or porosity and is then interspersed or infiltrated by another metal phase during sintering said phase forming what would be the matrix of the present invention if such technology was utilized to incorporate magnetic particles into a component.

In the case of the present invention magnetic particles are suitably treated, which may include etching and or multiple surface coatings to achieve ultimate magnetic capabilities while having excellent compatibility with the matrix material within which said particles are amalgamated.

U.S. Pat. No. 6,136,265 Gay filed Aug. 9, 1999 Powder Metallurgy method and articles formed thereby, generally relates to a process of coating metal particles with solid polymer binders, lubricants and other materials prior to compaction.

A number of the above reference patent example disclose methods associated with Powder Metallurgy and Metal Matrix Composites, there are numerous other methods which can be equally well employed to incorporate embodiments of the present invention. It has also been mentioned in prior sections of this disclosure that regions of a component which contain a high concentration of magnetic particles will often become brittle and suffer a lack of ductility, tensile strength and impact resistance. Therefore improved tensile capacity and impact resistance can prove to be a limiting factor in some mechanisms especially those exposed to high stresses for example, high speed flywheels. Additional reinforcement of such components can be achieved by incorporating into the structure of the component flexible high tensile fibre filaments as example carbon, boron, aromatic polymide, ceramic and other fibres which may be specifically distributed along lines of stress or randomly distributed through the particle binding matrix and or the component matrix.

U.S. Pat. No. 4,676,722 Koenig filed Jun. 30, 1987 High Peripheral Speed wheel for a Centrifugal Compressor.

The disclosure explains the use of fibres and filaments of carbon, boron glass or aromatic polymide utilizing a resin bonding agent of epoxy, polyimide or phenolic resin. Such a component formation can easily accommodate specifically located concentrations of magnetic particles to provide a component of high structural integrity which performs its primary function while additionally integrating magnetic field producing medium within said components matrix or structural matrix.

Developments in metallurgy also allow the integration of such reinforcing fibres within the matrix of a metal matrix component, which for the purposes of the present invention can also integrate magnetic particles in specifically located concentrations thereby creating a fully integrated structural material or component.

Methods and principles of the present invention can be utilized to manufacture large or small magnetic components. These can, for example, be a unitary magnetic system with a North-South Pole or a multi-pole system wherein the magnetic material is concentrated in a required specific region and integrated and amalgamated into a matrix material which can be strong and ductile and can be used to attach; via. Bolts, Rivets, welds or alternatives; said unitary magnetic system. A far superior system to the prior art which is comprised purely of a homogeneous blend of magnetic particles and metal matrix binder which is generally too brittle to bolt or rivet and not easily welded or brazed. The “new” unitary magnetic systems can be large or small and differs totally from the homogenous blend of particles and binder which form the prior art permanent magnet. The present invention utilizing specifically located concentrations of magnetic particles where they are most beneficial, altering the concentrations within the integrated material in varying concentrations to suit requirements of the location and utilizing a gradation of particles blending into the matrix material forming a non homogenous blend of particles within a matrix material such that the characteristics of the matrix material are utilized in regions requiring such characteristics for example a ductile non brittle matrix material required for bolting to a primary component.

For the purposes of the present invention a Distributed Magnetic Metal Matrix Composite shall describe a material conforming to a generally non-homogeneous distribution of magnetic particles within a material of another metal or different magnetic particles wherein magnetic particle concentrations are specifically located so as to achieve the design requirements of both the magnetic material and the structural load bearing material.

As with plastic/resin matrix composites Metal Matrix Composites can have large strength and modulus gains as a result of incorporation of reinforcing fibres such as carbon, boron, glass fibres, Kevlar (polyaramid), or other suitable fibres. Short randomly oriented fibres can be mixed into the matrix, while in particle or liquid (molten) form or mixed with the magnetic particles or both, thereby significantly improving structural characteristics and particularly, rigidity, tensile and bending strength, impact and fatigue resistance thereby allowing a thinner, lighter weight load bearing section. Additionally longer or “continuous” strands of reinforcing fibres can be specifically located within the Distributed Magnetic Metal Matrix Composite to provide additional strength, for example improved tensile and compressive strength and improved modules of elasticity and thus rigidity of a component, for example, carbon fibres integrated and firmly bonded in specific locations within an aluminium matrix can greatly improve structural characteristics. The same carbon fibre strands passing around or through regions containing high proportions of magnetic particles can likewise greatly improve structural integrity, for instance tensile, bending strength, and fatigue loading and greatly improve safety factors against component failure said fibres are often suitably coated for compatibility with the chosen matrix material.

Present technology allows “easy” access to such materials and the technology to include these reinforcing fibres in metal matrix materials. The following references describe a small portion of the available technology.

U.S. Pat. No. 4,731,298 Shindo et.al. filed Dec. 9, 1985, Carbon fibre-reinforced light metal composites, discloses carbon fibres bound with aluminium or aluminium alloy or magnesium/magnesium alloy to form a metal fibre composite. Methods of component manufacture include molten metal impregnation, and stir casting as example. Titanium boron coatings are also mentioned and titanium is potentially a matrix material used with distributed magnetic particles to form a light weight high strength magnetic field generating component with both a structural components use such as a wheel rim or motor/generator high speed rotor and a magnetic field generating capability as defined by a Synthetic Multifunctional Material which was defined and claimed by the Inventor of the present invention in U.S. Pat. No. 7,703,717.

U.S. Pat. No. 5,733,390 Kingston, filed Dec. 7, 1995. Carbon Titanium composites discloses methods for coating carbon fibres to achieve compatibility with a titanium matrix, however in this case the fibre is surface bonded to the metal. This patent also clearly states a few deficiencies associated with resin/plastic bound composites which include damage sensitivity, low bearing strength and fastening difficulties.

Surface bonding of high strength fibre reinforcement can be considered an option with some specialized components and has an advantage of being able to easily vary the amount and orientation of the carbon fibre or alternative fibre in order to put the required strength where it is needed.

Nickel and other coatings can be applied to reinforcing fibres to act as wetting agents and to assist compatibility with the matrix material.

U.S. Pat. No. 5,468,358 Ohkawa et.al. filed Jul. 6, 1993 Fabrication of fiber-reinforced composites which include those of carbon, ceramic, or metal matrix composites using electro-phoretic infiltration of an array or preform which is a quite complex procedure suited to high end usage.

U.S. Pat. No. 5,162,159 Tenhover et al. filed Nov. 14, 1991 Metal alloy coated reinforcements for use in metal matrix composites, utilize carbon fibre, silicon carbide fibre or other suitable fibres and provides a coating which allows compatibility with the matrix metal and resists high temperature degradation of the fibres.

U.S. Pat. No. 6,033,622 Maruyama filed Sep. 21, 1998. Method for Making Metal Matrix Composites which discloses a composite material comprising a metal matrix reinforced with particles of silicon carbide for example, using powder metallurgy wherein a metal alloy powder and a particulate powder are mixed then consolidated at elevated temperature is an example of prior art and could easily include short reinforcing fibres of carbon, boron, silicon carbide or suitable alternatives plus magnetic particles which as with the other particulate materials should also be suitably coated for compatibility with the matrix. Particles can be coated with a material compatible with the metal matrix material to ease wetting and amalgamation wherein a non homogeneous particle blend forms an integrated structural material.

Magnetizing the particles prior to mixing with the matrix, then utilizing a magnetizing array of magnetic fields to hold magnetic particles in specific locations within a mold containing said magnetic particles, or preforms of magnetic particles, and if desired reinforcing fibres along with either matrix particles or molten matrix material. A magnetizing field can be applied during consolidation of the component body within the mold and or can be applied to the final solid body to “set” magnetic fields, arrays and pole alignments.

U.S. Pat. No. 6,154,352 Kais filed Mar. 27, 1997 Method of Magnetizing a Cylindrical Body discloses interesting technology which can be applied to components utilizing embodiments of the present invention.

Also of interest is Talat Lecture 1402 Aluminium Matrix Composites Materials Advanced Level 1—L. Froyen, University of Leuven, Belgium, referencing methods of manufacture of Aluminium Matrix Composites which is relevant to a number of other metal matrix materials, continuous and discontinuous short fibre composites, particle composites, manufacturing techniques, and application examples, automotive, aerospace, electronics (due to good heat dissipation) sports and leisure. This paper clearly shows the viability and ease of manufacture of the present invention by utilizing technology associated with Metal Matrix Composites, Sintered and Metal Bonded Magnets, and a range of Metallurgical Techniques available to those skilled in the art. Ref. “Conventional Powered Metal Components” bear similarity to metal matrix components and provide very important technology for the manufacture of embodiments of the present invention Ref. www.mpif-org/design centre/conventional.pdf. Another interesting Reference that highlights potential beneficial uses of the present invention is; Ref:—Proceeding of the Federal Transit Administrations Urban Maglev Workshop Washington D.C. Sep. 8-9, 2005. Several Maglev transport levitation systems make usage of “Halbach” arrays above and or below a track of transposed conductors the “Diagonal V” array can be used in place of a “Halbach” array with potential benefits in magnetic field strength and more highly concentrated flux peaks for a set quantity of magnetic material usage. Embodiments of the present invention using either “normal” magnet segments or magnetic particle embodiments, in a “Diagonal” or “V” array or “Halbach” array using magnetic particles in a structural metal matrix can provide benefits over that of the prior art.

It should be noted that the “Diagonal ” or “V” Magnet Array which is relevant to magnet segments or magnetic particle formed arrays is analogous to the electrically induced field equivalent “V” coil array thus said “V” coil array can offer significant advantages especially when combined with the “Diagonal” or “V” magnetic array, as example a rotor incorporating and integrating magnetic particles in a “Diagonal” or “V” array interacting with a “V” coil array in a stator field coil arrangement with no requirement for magnetic flux back iron. The matrix material which integrates the magnetic material of the “V” coil core can form for example an integrated motor case which can be of a variety of materials for example, aluminium, magnesium, plastic or suitable alternative since there is no requirement for back iron as the “V” coil forms a continuous flux path. Embodiments of the present invention can be beneficial and find usage in Maglev Vehicles referenced.

To verify the viability of the “Diagonal” or “V” magnet array and analogous “V” coil array a very simple experiment was performed comparing the “Diagonal” or “V” magnet array with the “Halbach” magnet array using a primary criteria with each array of equivalent amount of magnetic material. (Important for cost and weight considerations) Each of the two arrays used 5 “identical” 10 mm. long by 5 mm. diameter (Nd Fe B) round bar or rod magnets.

The arrays were mounted in a 10 mm. by 10 mm. by approximately 50 mm. long section of soft wood. One section for each array. Holes just smaller than the diameter of the magnet segments (rods) were drilled to correspond with “Halbach” and “Diagonal” or “V” arrays. In the case of the “Halbach” array 3 vertical rods North-South-North were placed in vertical, (relative to horizontal work table), drill holes. The lower sections between vertical magnets was recessed to allows placement of 2 horizontal magnets acting as the back face flux path of the “Halbach” arrays. Refer to drawings. The “Diagonal” or “V” array was formed by drilling holes in “V” formation at a drill angle of approximately 45 degrees off vertical and 5 rod magnets were pushed into the holes with the upper face being the “reinforcing field” face and magnets installed south touching south, gap, north touching north, gap, south, while the lower face has north touching south and acts as the return or back flux path which is very short and therein advantageous while the upper reinforcing face creates highly concentrated north and south flux densities which will improve induced fields as a result of interaction with a moving conductor passing through such an array which is an added benefit to the total field strength produced by the 5 magnet rods.

The total field strength for particular magnet arrays using the same amount of magnetic material is representative of the attraction force or repulsion force of a particular array, important in, for example a magnetic bearing or levitating device, while a levitating device that functions as a result of induced fields benefit greatly as is also the case with most electric motor drives which rely on both magnetic field strength and a rapid rise and “decay” of a high density flux.

In this experiment we are checking only the levitating or lifting ability of the two arrays by measuring the distance between the reinforcing magnet array surface placed horizontal to the work table and a standard weight (steel ruler) being levitated (lifted) vertically upward.

The distance at which levitation occurred was measured by a vernier guage attached to the arrays mounted on the soft wood and touching the work table surface to measure the distance at which levitation or lifting of the weight occurred by both the reinforcing faces and the return flux back face fields for “Halbach” and “Diagonal” or “V” arrays.

The average results are listed below and were highly repeatable with a variation of no more than 0.05 mm. It should also be noted that this experiment gives only comparative results of the overall field strengths and “back face” strengths, of a “Halbach” array compared with a “Diagonal” or “V”, magnetic field array.

Arrays were aligned parallel to the ruler being lifted. The average height of the array above the standard weight at which levitation occurred for both the reinforcing “front” face of the array and the back “flux return path” were “Halbach” array reinforcing 8.50 mm. back face 5.75 mm. “Diagonal” or “V” array reinforcing 10.25 mm. back face 5.85 mm.

Conclusion; the total magnetic field strength of a fixed amount of magnetic material for the reinforcing side of the array is significantly greater for the “Diagonal” or “V” array than the “Halbach” array, and since magnetic field strength decreases in an approximately exponential function relative to distance the “Diagonal” or “V” array appears to offer approximately a 20% increase in field strength to that of the “Halbach” array plus potentially “sharper” flux peaks.

Another very significant advantage of the “Diagonal” or “V” especially where complex component shapes are involved is the ease of magnetizing the “V” array.

For the purposes of the present invention magnetic particles shall define; permanently magnetic particles, soft magnetic particles which become magnetic under the influence of a magnetic field, an assembly of electrically conductive particles which become magnetic under the influence of a changing magnetic field, or material particles which under the influence of mechanical forces generate magnetic field forces.

For the purposes of the present invention magnetic field and electro-magnetic field interactive materials/items/components can be defined as magnetic field interactive as per a prior definition. As example a machine, a mechanism, a mechanical appliance, a component of a machine, shall define a magnetic field interactive item wherein said item possesses magnetic field forces and the capacity to impose the influence of said magnetic field forces on other items, wherein said other items would also be defined as magnetic field interactive items since these items exhibit a capability of being influenced by magnetic field forces. As example virtually all electric machines are motivated as a result of an electrical current giving rise to magnetic field forces which then interact with other items which are directly influenced by the interaction with said magnetic field forces. A permanent magnetic motor/generator is also a magnetic field interactive machine as is a magnetic power transfer system, as is an eddy current braking system, as are for the purposes of the present disclosure all items which function or operate as a result of the influence or interaction of a magnetic field force wherein all such items being mechanisms, machines, components or materials there of shall be defined as being magnetic interactive.

With respect to the above description the optimum dimensional relationships for the components of the invention, to include variations in size, materials, shape, form, function and manner of operation, assembly and use, are deemed readily apparent and obvious to one skilled in the art and all equivalent relationships to those in the drawings and described in the specification are intended to be encompassed by the present invention.

Therefore the foregoing is considered as illustrative only of the principles of the invention. It is not desired to limit the invention to the exact construction, operation and usage shown and described, thus all suitable modifications and equivalents may be considered to fall within the scope of the invention.

I claim:

1. A material, being part of a component, comprising specifically located concentrations of magnetic particles incorporated into at least one of; a matrix of a different metal, a structural matrix of a different metal, a matrix of another type of magnetic particle, thereby creating a non homogeneous amalgamated material forming an integrated component possessing and sustaining magnetic field interactive capabilities, said material being defined as a distributed magnetic metal matrix composite material, and said integrated component being defined as a magnetic field interactive component.

2. The material of claim 1, being part of a component defined as a magnetic field interactive component wherein said component forms part of a mechanism, being a mechanical device, incorporated into but not restricted to; an integrated magnetic multi-pole array, a hybrid vehicle, an electric vehicle, a car, a bus, a cycle, a truck, a train, an aircraft, an electric motor/generator, an electric pump, a magnetic torque transfer pump, a vehicle auxiliary drive motor, a fan, a magnetic torque transfer system, a magnetic gear box, a pseudo-direct drive motor/generator, a magnetic bearing, a magnetic castor, a magnetically supported shaft, an integrated wheel motor/generator system, a magnetic field levitated vehicle, an electric hand tool, an electric household appliance, a linear drive motor/actuator, a tubular linear drive motor/actuator, a wheel rim, a wheel hub, a rotor disk, a rotor and stator of an electric motor, a brake rotor disk, a drive shaft, a gearbox component, a fly wheel, a steering rack and pinion servo-system, wherein said mechanism possesses structural and architectural attributes associated with the mechanism while also possessing magnetic field interactive capabilities.

3. The material of claim 1 wherein said material forms a magnetic component of a magnetic field interactive mechanism such that the magnetic component exhibits a specifically located and aligned primary magnetic field force which is interacted upon by a secondary magnetic field force which reinforces the primary magnetic field force thereby increasing said magnetic components capacity to generate torque, power, and energy while eliminating demagnetization potential at the increased capacity of the magnetic component and also allowing flux weakening of the magnetic component by reducing the reinforcing effects of the secondary magnetic field force, wherein said secondary magnetic field force is created by, but not restricted to ; a co-axial coil winding, a remote acting magnetic flux imposing co-axial flux on the primary magnetic field force, thereby creating a magnetic flux variable mechanism with demagnetizing protection and flux weakening ability resulting in a more efficient mechanism.

4. The material of claim 1 wherein said material is formed into a “V” formation in cross section, therein providing a basis on which a magnetic coil array is formed, said coil array being one of but not restricted to;
a stator drive coil, a rotor drive coil, a linear drive coil winding, a reinforcing coil associated with a magnetic material, wherein an array of “V” coil wound cores comprises the magnetic particles of claim 1 being at least one of but not restricted to;
a core material utilizing permanently magnetic particles reinforced with co-axial coils, a core material utilizing soft magnetic particles with co-axial coil windings, a core formed of non magnetic material in place of magnetic particles therein acting similarly to an air core while supporting a “V” coil formation, wherein the coil is;
wound externally around a core, formed into a core structural matrix, inserted into a co-axial hollow section within said core, whereby a magnetic flux and associated magnetic poles are created by;
permanently magnetic particles, electrical current flow within co-axially acting coils associated with a soft magnetic particle core, electrical current flow within coils associated with non magnetic core material which is utilized in place of magnetic particles, induced in electrically conductive particles by a changing interactive magnetic field, wherein said “V” cores are arranged so that a wide section of a “V” faces an air gap and like poles are in proximity to like poles and adjacent to an air gap creating reinforcing fields while a base of a “V” which is integrated into a component matrix forms a non like pole region of a back flux return path, therein eliminating a need for back iron.

5. The material of claim 1 comprising magnetic particles which give rise to magnetic field forces specifically aligned, located and concentrated within at least one of;
a component matrix, a component structural matrix, forming a non homogeneous amalgamation of magnetic particles which create a specific magnetic field array which forms an integrated magnetic multi-pole array being at least one of, but not restricted to;
a “Diagonal V” array, having a “V” shaped array wherein a wide section of the “V” faces an air gap and like poles are in proximity to like poles and adjacent to the air gap with pairs of like poles all facing the air gap therein creating a reinforcing magnetic field with non like poles joining at a base point of the “V” forming back face flux return paths which eliminate any necessity for back iron within a component matrix material into which the “V” base is amalgamated;
a “Halbach” array utilizing said integrated magnetic multi-pole array as was utilized with the “Diagonal V” array, whereby both the “Diagonal V” array and the “Halbach” array concentrate magnetic flux on an air gap face;
a like pole to like pole array created utilizing an integrated magnetic flux at like pole interfaces creating intense flux concentrations as is an advantage of the “Diagonal V” array however unlike the “Diagonal V” array this array does not concentrate flux on one side;
a conventional alternating north, south pole array easily created utilizing an integrated magnetic multi-pole array, wherein all magnetic field arrays hereby defined form a material with integrated magnetic particle concentrations specifically located within a metal matrix component said material being defined as a distributed magnetic metal matrix composite which forms an integrated component.

6. The material of claim 5 which is defined as a distributed magnetic metal matrix composite material wherein said material forms a magnetic field interactive component with an integrated multi-pole magnetic array being one of, but not restricted to;
a “Diagonal V” array, a “Halbach” array, wherein said integrated magnetic multi-pole array is incorporated into a specific component and provides a primary source of passive magnetic field flux for, but not restricted to;
a magnetic levitation vehicle, a magnetic bearing, a permanent magnet rotor of an electric machine, a multiple disk motor/generator, a flywheel mechanism with motor/generator capabilities, a component of a vehicle transmission assembly therein providing an addition motor/generator capability to said component, integrated into a component of a vehicle drive assembly including a wheel assembly, thereby enabling said component with an additional motor/generator capability, which is utilized as a powerful magnetic array integrated into a vehicle component such as;
a steering rack, therein performing a function of a tubular linear motor providing frictionless servo assistance to a steering rack, providing high strength magnetic fields incorporated into a vehicle wheel rim, therein creating a structurally integrated in-wheel motor/generator, utilized in place of a conventional disk brake, to allow the formation of a combined motor/generator and friction disk brake, said magnetic field interactive component possessing structural and architectural characteristics associated with a specific component while also sustaining magnetic field generating capabilities.

7. The material of claim 1 comprising specifically located concentrations of magnetic particles wherein said magnetic particles are at least one of; permanently magnetic particles, soft magnetic particles, electrically conductive particles which become magnetically interactive under the influence of a varying magnetic field, piezoelectric particles which emit magnetic field forces as a result of an imposed force, combinations of said listed particles.

8. The material of claim 1 which can be utilized in a wide array of magnet field interactive components and mechanisms, one type of which, is a permanent magnet rotor synchronous electric motor/generator with coil wound salient stator poles which interact with a rotor of a type with, but not restricted to;
a solid cylindrical form, a hollow cylindrical form with metal spoke shaped material which is fibre reinforced for added structural integrity linking a peripheral region maintaining magnetic field flux with an inner axial support region wherein voids between the spoke shaped material save matrix material, reduces weight and eases magnetizing of the peripheral region, said rotor having a peripheral region comprised of a distributed magnetic metal matrix composite material which utilizes a rotor of alternating north, gap, south magnetic poles, aligned axially along a rotor peripheral surface length, which comprise arrays of magnetic particles, with adjoining flux return paths eliminating a need for back iron, incorporated into a non homogeneous amalgamation within a metal matrix of a different metal to that of the magnetic particles wherein an integrated magnetic multi-pole rotor is formed which possesses magnetic flux which interacts with electronically controlled salient coil wound stator core poles evenly disposed in an axial alignment within a motor casing with an air gap separating said stator core poles from a rotor periphery wherein stator cores are formed from soft magnetic particles of a different metal to that of the casing matrix, which are integrated into the motor casing so as to form a distributed magnetic metal matrix composite with magnetic particles blending into the motor casing matrix and forming a continuity of flux paths between the stator core poles therein eliminating a need for back iron, said salient coil wound stator poles being, but not restricted to;
unitary protruding blocks, “V” cores with “V” coils which create a flux return path within a “V” base which amalgamates with matrix metal forming a casing therein further reducing back face flux path over that of a block shaped stator core pole which requires a flux path linking pole blocks, said “V” coil and associated “V” core additionally improves casing structural integrity, said “V” coils also producing highly concentrated flux densities, wherein said motor/generator utilize distributed magnetic metal matrix composite material in a rotor and a combined stator and motor casing.

9. The material of claim 1, forming part of a magnetic field interactive component associated with passive and actively controlled magnetically levitated vehicles having operating principles which have similarity to passive and actively controlled magnetic bearings wherein said magnetically levitated vehicles utilize a distributed magnetic metal matrix composite to form an integrated magnetic multi-pole array of permanently magnetic particles incorporated into a metal matrix of a different metal to that of the magnetic particles in place of a permanent magnet segment array wherein said integrated magnetic multi-pole array is arranged in;
a “Diagonal V” array, a “Halbach” array, a suitable alternative array, whereby at least one method of levitation is utilized this being one of two alternatives;
a passive system of moving magnetic field arrays which interact with a track of disposed conductors of at least one of
shorted coils, stacks of insulated conductive laminates, a suitable alternative inductive material, to create opposing inductive forces in said track which levitate a vehicle, a second alternative being;
an active system of magnetic field arrays which are attracted to a magnetically interactive component, being but not restricted to;
a similar magnetic array to that of the passive system with non like poles adjacent to one another across an air gap, a soft magnetic metal in proximity across an air gap wherein at least one magnetic array has co-axially acting electronically controlled electro-magnetic flux adjusting overall field strength while monitoring relative location between interactive magnetic components, thereby maintaining a stable air gap width and allowing stable levitation of a vehicle.

10. The material of claim 1 comprising magnetic particles which give rise to magnetic field forces incorporated within a structural matrix of a passive magnetic bearing which forms an axial support shaft of a combined motor and generator mechanism, said axial support shaft being at least one of;
an integrated part of the passive magnetic bearing, a support for a separate attachment of an integrated multi-pole array forming an inner section of a passive magnetic bearing, wherein an opposing magnetic field results from one of two alternatives;
a first alternative being a cylinder of disposed conductors rigidly mounted around a periphery of said passive magnetic bearing of the axial support shaft, composed of but not restricted to;
shorted conductive coils, insulated conductive laminates in which an opposing interactive magnetic field is induced by axially aligned flux poles of said passive magnetic bearing associated with the axial support shaft which includes an attachment to said axial support shaft;
a second alternative being an integrated magnetic multi-pole array rigidly contained in proximity to an axial support shaft comprising a magnetic array wherein the passive magnetic bearing associated with the axial support shaft has like poles of a magnetic array opposing a rigidly contained integrated magnetic multi-pole array aligned across an air gap so that like poles of magnetic arrays are opposite one another in a repulsion mode, wherein said magnetic array is;
a “Diagonal V” array, a “Halbach” array, a suitable alternative array with a capacity to provide radial and axial support to a shaft as a result of;
forming said passive bearing with a conical formation which applies magnetic flux forces with axial and radial components and results in axial and radial shaft support which can be enhanced in terms of shaft stability by combining induced repulsion effects with those of purely magnetic repulsion effects.

11. A magnetic field interactive mechanism forming a mechanical device comprising magnetic particles which give rise to magnetic field forces, wherein said magnetic particles are incorporated in specifically located concentrations, within a structural matrix of a different material comprising at least one of; a metal matrix, a non metal matrix, a magnetic particle matrix of another type of magnetic particle, wherein incorporation of said magnetic particles forms a non homogeneous amalgamated material comprising assimilated concentrations of magnetic particles incorporated into said structural matrix to form an integrated structural component possessing magnetic field interactive capabilities which is thereby defined as a “multifunctional” mechanism.

12. The magnetic field interactive mechanism of claim 11 comprising magnetic particles which give rise to magnetic field forces incorporated in specifically located concentrations within a structural matrix of a disk of a different material to that of the magnetic particles creating a mechanism of axially supported rotational disks which as example, comprises two disks, said disks including a space between disks which locates a suitable disk shaped drive coil with air gaps between interior faces and the drive coil wherein said disks incorporate integrated magnetic multi-pole arrays, being at least one of; a “Diagonal V” array, a “Halbach” array, a suitable alternative array, wherein high intensity magnetic flux fields are created on inner disk surfaces adjacent to the drive coil creating an interaction between drive coil flux and disk magnetic flux which give rise to rotational torque forces, said disk and drive coil mechanism forming part of, but not restricted to; a combined motor and generator which in this example replaces a friction brake disk mounted co-axially within a wheel assembly, said disk and coil assembly additionally including an integral friction brake disk whereby said disk and coil assembly provides the wheel assembly with integral capabilities of a motor, a generator, a friction brake, and a regenerative brake.

13. The magnetic field interactive mechanism of claim 11 comprising a non homogeneous material incorporating concentrations of magnetic particles wherein a wide array of magnetic particle concentration distributions can be utilized; varying in an axial direction, varying in a radial direction, varying in a circumferential direction, thus as example, in an array magnetic particles form a uniform surface concentration around a cylindrical rotors surface region, there being a variation in a radial direction from a highly concentrated magnetic particle distribution in the rotors surface region deminishing to primarily a matrix material within inner regions of a rotor, particles being incorporated and amalgamated into a matrix material so as to form a structurally and architecturally integrated component with a peripheral surface of uniform concentrations of magnetic particles which in an array of this example forms a multi-pole magnetic array over said rotors surface region.

14. The magnetic field interactive mechanism of claim 11 comprising magnetic particles which give rise to magnetic field forces, wherein said magnetic particles are incorporated in specifically located concentrations within an electric motor casings structural matrix, said casing comprising permanently magnetic particles incorporated within said casing of;
metallic non magnetic material, non metallic material, particles of a different type of magnetic particle, a suitable material additionally reinforced with incorporated fibres, wherein said permanently magnetic particles form a magnetic array being at least one of;
a “Diagonal V” array, a “Halbach” array, a suitable alternative array, forming a non homogeneous amalgamation of permanently magnetic particles incorporated and assimilated into another material matrix to form an integrated structural casing of, in this example an electric motor utilizing a coil wound rotor with at least one of;
commutator power supply to rotor coils, slip rings plus electronic control of power delivery to rotor coils, a suitable alternative means of power supply to rotor coils, wherein a magnetic flux associated with said coil wound rotor interacts with permanently magnetic particle arrays which are;
non flux reinforced permanently magnetic particle arrays, reinforced with co-axially applied magnetic flux to eliminate a risk of demagnetization of permanently magnetic particles while allowing increased motor torque and field weakening capabilities due to reducing coaxially applied magnetic flux at high motor speeds thereby reducing back emf in the coil wound rotor, wherein a highly efficient motor is created.

15. The magnetic field interactive mechanism of claim 11 comprising magnetic particles which give rise to magnetic field forces incorporated in specifically located concentrations within a structural matrix of a different material to that of the magnetic particles creating a vehicle associated mechanism being at least one of;
a wheel rim, an addition to a wheel rim, a wheel hub, a suitable rotational component, utilizing integrated magnetic multi-pole arrays comprising at least one of;
a “Diagonal V” array, a “Halbach” array, a suitable alternative array, wherein high intensity magnetic fields are created in a surface of said vehicle associated mechanism adjacent to a drive coil wherein an interaction between drive coil flux and the integrated magnetic multi-pole arrays give rise to rotational torque forces acting on the vehicle associated mechanism creating a combined motor and generator thereby defining said vehicle associated mechanism as a multifunctional mechanism possessing architectural and structural load bearing functions associated with, as example a wheel rim, while integrating specific magnetic flux arrays thereby creating an in wheel combined motor and generator with regenerative braking capabilities.

16. The magnetic field interactive mechanism of claim 11 comprising magnetic particles which give rise to magnetic field forces incorporated in specifically located concentrations within a structural matrix of a different material to that of the magnetic particles creating a vehicle associated steering rack servo-assistance mechanism utilizing integrated magnetic multi-pole arrays comprising at least one of; a “Diagonal V” array, a “Halbach” array, a suitable alternative array, wherein high intensity magnetic fields are created within a steering rack gear rod incorporating said integrated magnetic multi-pole arrays in proximity to a drive coil incorporated within a casing enveloping said steering rack gear rod, wherein an interaction between drive coil flux and the integrated magnetic multi-pole arrays of the steering rack gear rod give rise to a linear drive force acting on said steering rack gear rod, wherein said vehicle associated steering rack servo-assistance mechanism provides functions associated with a steering rack while comprising magnetic particles in integrated magnetic multi-pole arrays within a steering rack structural matrix to provide servo-assistance to a steering rack.

17. A process for manufacturing a distributed magnetic metal matrix composite material utilizing metallurgical techniques and technology wherein specifically located concentrations of magnetic particles are bound in a non homogeneous amalgamation within; a metal matrix of a different metal to that of the magnetic particles, a metal structural matrix of a different metal to that of the magnetic particles, a different magnetic particle forming a matrix, a combination of two or more metal matrix types, thereby forming an integrated material with magnetic field interactive capabilities.

18. The process for manufacturing a distributed magnetic metal matrix composite material of claim 17 wherein said specifically located concentrations of magnetic particles comprises at least one of;
loose unbound magnetic particles, magnetic particles bound into a preform, a blend of more than one type of magnetic particles, a blend of magnetic particles and metal matrix particles of a different metal, a blend of magnetic particles and a flowable fluid form of metal matrix material of a different metal to that of the magnetic particles, wherein said magnetic particles are specifically distributed and aligned to form concentrations of specifically located magnetic particles which form localized arrays of magnetic particles within at least;
a matrix of a different metal, a structural matrix of a different metal, a matrix of different magnetic particles thereby forming a non homogeneous material with magnetic interactive capabilities.

19. The process for manufacturing a distributed magnetic metal matrix composite material of claim 17 wherein a mold consists of, but is not restricted to;
upper and lower former plates which incorporate specific magnetic flux arrays, associated mold sides, said mold containing a specific quantity of at least one of;
a blend of magnetic particles and non magnetic metallic matrix particles, a blend of magnetic particles and metallic matrix particles of a differing magnetic field interactive capacity to that of the magnetic particles, a blend of magnetic particles and different magnetic particles wherein said different magnetic particles also possess different magnetic field interactive capacity, a blend of magnetic particles and a flowable fluid form of metal matrix material of a different type of metal to that of the magnetic particles and possessing differing magnetic field interactive capacity to that of the magnetic particles, wherein prior to said mold contents sustaining heat and pressure, mold applied magnetic field forces act on the blend of magnetic particles and matrix metal whereby said magnetic field forces, which mirror magnetic arrays required in a finished component, concentrate magnetic particles in specific locations and arrangements and align anisotropic magnetic particles, said magnetic field forces being assisted in separating, concentrating and aligning by, but not restricted to;
creation of a fluidized particle bed by gaseous intrusion, vibration of the mold utilizing;
mechanical, magnetic, acoustic or suitable alternative means, thereby creating a distributed magnetic metal matrix composite component.

20. The process of manufacturing a distributed metal matrix composite material of claim 19 wherein an alternative method to magnetic field concentration of magnetic particles is desired;
when magnetic particles and a matrix metal have similar magnetic field interactive capacity;
when complex arrays must be formed, whereby said concentrations of specifically located magnetic particles is achieved by forming magnetic particle preforms, said preforms being premagnetized in specific magnetic flux arrays prior to installation into the mold, said preforms alternatively being magnetized upon installation into the mold by said mold applied magnetic field forces, wherein mold flux also assists in maintaining said preform in position, said mold containing a specific amount of matrix metal in addition to the preforms, said matrix metal being in a;
particle form, a flowable molten liquid form, a plastic form, a fluidized particle form, wherein contents of said mold are subjected to heat and pressure which fuses and sinters magnetic particles and forces matrix material into porous regions of the preform, a process which can be assisted by special pre-coating on particles, thereby creating an integrated multi-pole array within a component.
